(19) United States
(12) Patent Application Publication
(10) Pub. No.: US 2026/0211952 A1
(43) Pub. Date: Jul. 23, 2026

(54) AUTOMATED DOCUMENT STRUCTURE ANALYSIS AND APPLICATIONS

(71) Applicant: Workday, Inc., Pleasanton, CA (US)

(72) Inventor: Mike Chiang, Vancouver (CA)

(21) Appl. No.: 19/029,339

(22) Filed: Jan. 17, 2025

(51) Int. Cl. G06F 16/93; G06F 40/151; G06V 30/416

(52) U.S. Cl. CPC G06F 16/93

(57) ABSTRACT

A system, method, and device for determining document structures are provided. The method obtains an input document and determines an index of the input document based on the document structure for the input document. The method includes (i) obtaining input text for an input document, (ii) obtaining an output object for the input document, and (iii) providing the output object. The obtaining the input text includes (a) querying a first machine learning model to obtain a machine-readable object that indicates a document structure for the input text, and (b) performing a post-processing of the machine-readable object to obtain the output object, wherein the post-processing comprises correcting errors introduced by the first machine learning model. The post-processing corrects errors introduced by the machine learning model.

### BACKGROUND OF THE INVENTION

Modern organizations manage an increasing volume of complex documents, such as contracts, technical manuals, medical records, and legal documents. These documents often contain unstructured or semi-structured information, making it challenging to extract meaningful data or organize them efficiently. Determining the structure of such documents, including identifying sections, headers, sub-headers, and cross-references, is a critical task for automating processes such as indexing, summarization, compliance verification, and sensitive information management. However, traditional rule-based methods for document processing often fail to handle the diverse formats and inconsistencies inherent in real-world document collections.

### BRIEF DESCRIPTION OF THE DRAWINGS

Various embodiments of the invention are disclosed in the following detailed description and the accompanying drawings.

FIG. 1 is a block diagram of a network system according to various embodiments.

FIG. 2A is an example of an input document according to various embodiments.

FIG. 2B is an example of at least part of a machine-readable object generated based at least in part on the input document.

FIG. 3 is an example of performing sub-header discovery for an input document based at least in part on a machine-readable object for the input document according to various embodiments.

FIG. 4 is a flow diagram of a method for obtaining an output object representing an input document according to various embodiments.

FIG. 5 is a flow diagram of a method for obtaining a machine-readable object associated with an input document according to various embodiments.

FIG. 6 is a flow diagram of a method for obtaining machine-readable text for an input document according to various embodiments.

FIG. 7 is a flow diagram of a method for obtaining machine-readable object for an input document according to various embodiments.

FIG. 8 is a flow diagram of a method for obtaining machine-readable object for an input document according to various embodiments.

FIG. 9 is a flow diagram of a method for post-processing a machine-readable object for an input document according to various embodiments.

FIG. 10 is a flow diagram of a method for post-processing a machine-readable object for an input document according to various embodiments.

FIG. 11 is a flow diagram of a method for obtaining machine-readable object for an input document according to various embodiments.

FIG. 12 is a flow diagram of a method for post-processing a machine-readable object for an input document according to various embodiments.

FIG. 13 is a flow diagram of a method for implementing a machine-readable object for an input document in connection with performing a function according to various embodiments.

FIG. 14 is a flow diagram of a method for identifying related documents based on machine-readable objects for a set of input documents according to various embodiments.

FIG. 15 is a flow diagram of a method for generating an aggregated document based on a set of related documents identified based on machine-readable objects for a set of input documents according to various embodiments.

FIG. 16 is a flow diagram of a method for identifying sensitive information in an input document based at least in part on a machine-readable object for the input document according to various embodiments.

FIG. 17 is a flow diagram of a method for enforcing a security policy with respect to sensitive information in an input document according to various embodiments.

FIG. 18 is a flow diagram of a method for deploying a model to detect errors in a machine-readable object according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a model includes a machine learning model and/or a deep learning model. In some embodiments, the model is a large language model (LLM). Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc.

According to various embodiments, advances in machine learning, particularly the development of LLMs, have opened new possibilities for understanding and processing unstructured text. LLMs excel in recognizing patterns, interpreting contextual meaning, and extracting structured information from diverse inputs. Despite their potential, challenges remain in efficiently integrating LLMs into document processing workflows. Issues such as managing the variability in document structure, handling errors introduced by machine learning models, and maintaining data integrity and security are significant obstacles to the practical application of these technologies.

There is a growing need for systems that can automate the analysis and organization of documents by leveraging the power of machine learning while addressing these challenges.

According to various embodiments, techniques for processing documents in connection with organizational documentation management may include one or more of converting input documents into machine-readable formats, determining their structure using intelligent algorithms, and outputting the extracted data in standardized formats. Furthermore, the techniques may additionally incorporate mechanisms for error correction, validation, and hierarchical organization to ensure the extracted information is accurate and complete. In embodiments, the system may leverage this document structure and/or other extracted information to implement additional functionality, which may include managing sensitive information, enforcing security policies or access controls, and creating cross-referenced representations of related documents, for example, in connection with improving compliance and operational efficiency.

Various embodiments provide a system that combines document pre-processing, machine learning models, and post-processing techniques to determine the structure of input documents. This system offers a scalable and intelligent solution to automate the analysis of non-machine-readable documents and/or unstructured and semi-structured documents. By implementing machine learning models (e.g., LLMs) and integrating post-processing or error-correction techniques, the system can ensure accurate, reliable, and secure document processing. Additionally, the system is configured to create indices, cross-references, and hierarchical representations.

According to various embodiments, a system and method for determining the structure of an input document is provided. The system leveraging machine learning models, particularly LLMs. The system can begin by pre-processing the input document to convert the input document into machine-readable text using techniques such as Optical Character Recognition (OCR). This pre-processed text (e.g., machine-readable text) serves as the input for further analysis and processing by the system.

In some embodiments, the system queries (e.g., once the text is converted) an LLM to identify and extract the input document's structure, such as section headers, based on the machine-readable text. The system can implement a segmentation approach, dividing the text into smaller segments (e.g., chunks) of predefined size (e.g., predefined number of characters, a predefined number of paragraphs, a predefined number of pages, etc.) to prompt the LLM iteratively. This segmentation allows the system to efficiently process lengthy documents, ensuring that all sections are examined comprehensively and to reduce errors generated by the LLM (e.g., the reduce the likelihood that the LLM will hallucinate). If no headers are identified within a threshold percentage of the document or a specific number of segments, the system may classify the document as unstructured and exclude it from further processing.

The extracted structure (e.g., the machine-readable object) is output in a predefined, machine-readable format such as JavaScript Object Notation (JSON), eXtensible Markup Language (XML), or Yet Another Markup Language (YAML). In some embodiments, the system further processes this machine-readable object to correct errors introduced by the LLM during the extraction phase. Error correction may involve implementing a set of predefined rules or another machine learning model specifically trained for the output format (e.g., specifically trained on JSON schema, etc.). In addition to correcting errors, the system can validate the extracted headers by ensuring their presence in the original text. Alternatively, the system can validate the extracted headers by ensuring the headers are consistent with the subject matter of the corresponding section text (e.g., in the case that the LLM infers headers based on the substance of the machine-readable text). In some embodiments, the system can also detect and resolve false negatives, such as missing headers, by analyzing section numbering or metadata inconsistencies.

In some embodiments, the system enhances the structural analysis by generating metadata that identifies where sections and sub-sections begin and end within the text. An example of this metadata is the character count for where a particular section begins and a character count for where a particular section ends. The character count may be the number of characters in the machine-readable text from the beginning of the document. In some embodiments, the system uses the metadata to enable further parsing the machine-readable text (e.g., the portion of text for the particular section for which sub-headers are being extracted) to extract sub-headers, allowing the system to create a hierarchical representation of the document's structure. The system can iteratively refine the structure across various hierarchical levels.

In some embodiments, the system uses the machine-readable object obtained by processing the input document to support advanced functionalities such as generating an index for the document, identifying cross-references within and across documents, identifying and protecting sensitive information, and creating a consolidated representation of related documents, such as contracts and their amendments. For example, the system can construct an amended and restated version of an agreement by combining its original text with subsequent amendments.

In some embodiments, the system uses the document structure (e.g., the machine-readable object) to detect and manage sensitive information, such as Personally Identifiable Information (PII) or Protected Health Information (PHI). By identifying sections likely to contain (e.g., expected to comprise) sensitive data, the system can enforce security policies, access controls, or redaction to ensure compliance with privacy standards and organizational policies.

The system according to various embodiments provides an efficient and scalable solution for analyzing, structuring, and managing complex documents, leveraging machine learning capabilities to streamline processes such as document indexing, cross-referencing, and sensitive information management.

Various embodiments provide a system, method, and device for determining document structures. The method obtains an input document and determines an index of the input document based on the document structure for the input document. The method includes (i) obtaining input text for an input document, (ii) querying a machine learning model to obtain a machine-readable object that indicates a document structure for the input text, (iii) performing a post-processing of the machine-readable object to obtain an output object, and (iv) providing the output object. The post-processing corrects errors introduced by the machine learning model.

Various embodiments provide a system, method, and device for determining document structures. The method obtains an input document and determines an index of the input document based on the document structure for the input document. The method includes (i) obtaining input text for an input document, (ii) obtaining an output object for the input document, and (iii) providing the output object. The obtaining the input text includes (a) querying a first machine learning model to obtain a machine-readable object that indicates a document structure for the input text, and (b) performing a post-processing of the machine-readable object to obtain the output object, wherein the post-processing comprises correcting errors introduced by the first machine learning model. The post-processing corrects errors introduced by the machine learning model.

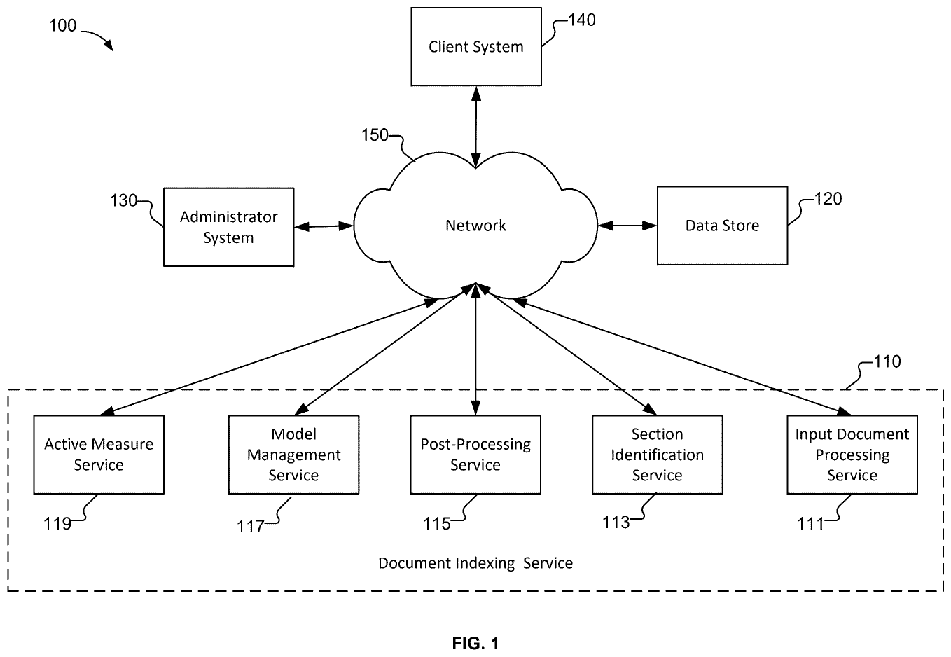

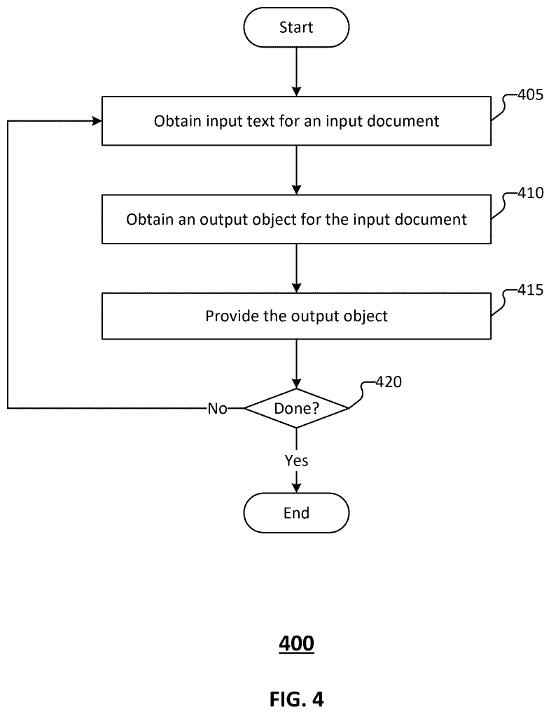

FIG. 1 is a block diagram of a network system according to various embodiments. In some embodiments, system 100 may implement one or more of processes 400-1800 of FIG. 4-18.

In the example shown, system 100 comprises document indexing service 110. In some embodiments, document indexing service 110 is configured to process input documents, obtain machine-readable text, identify document structures for the input documents, generate objects (e.g., machine-readable objects) indicating the document structure, use the objects and/or input documents in connection with performing higher-level functionality (e.g., identifying inter-document cross-referencing, intra-document cross-referencing, and/or sensitive information, or enforcing one or more security policies or access controls with respect to the input documents. Additionally, document indexing service develop, train, and/or refine a machine learning model (e.g., an LLM) to be deployed for a particular use case, such as a use case to parse machine-readable text for input documents to identify document structure, to validate information comprised in a machine-readable object generated by a different model, and/or to identify and/or correct errors within a particular machine-readable object (e.g., formatting or syntax errors, etc.). As illustrated, document indexing service 110 may include one or more of input document processing service 111, section identification service 113, post-processing service 115, model management service 117, and active measure service 119.

System 100 may additionally include one or more data stores, such as data store 120, and network 150 over which one or more of document indexing service 110, client system 140, administrator system 130, and data store 120 are connected. In some embodiments, document indexing service 110 is implemented by a plurality of servers. In various embodiments, network 150 includes one or more of a wired network and/or a wireless network such as a cellular network, a wireless local area network (WLAN), or any other appropriate network. System 100 may include various other systems or terminals.

According to various embodiments, system 100 (e.g., document indexing service 110) obtains a collection of input documents (e.g., a set of input documents) that are to be processed and/or for which high-level functionality is to be implemented. Input documents comprised in the collection of input documents can be manually uploaded and/or automatically gathered from designated sources through an established pipeline. The collection of input documents may include various document types (e.g., legal contracts, health records, corporate policies, etc.) and/or various document formats (e.g., pdf, images, etc.). For example, the collection of input documents can include a diverse collection of documents in various formats such as Portable Document Format (PDF) documents, word documents, presentations, diagrams, and images. This range of formats mirrors the real-world situation, where information is often spread across different sources and mediums. In some embodiments, the collection of input documents is stored in data store 120, from which document indexing service 110 may retrieve or otherwise access certain input documents.

In some embodiments, document indexing service 110 comprises input document processing service 111. Document indexing service 110 can use the input document processing service 111 to ensure a particular input document is in a format suitable for subsequent analysis. The input document processing service 111 can process input documents as they are received and added to the collection of documents, such as individually or in batches, or upon document indexing service 110 receiving a request (e.g., from client system 140) to access an input document or to obtain an index or document structure for the input document. For image-based or non-text formats, such as scanned PDFs or images, input document processing service 111 can implement OCR technology to convert the input document's visual content into machine-readable text. The OCR process identifies and extracts textual elements from the document's layout, transforming them into a structured digital format. Input document processing service 111 may additionally implement advanced OCR techniques or processing techniques to ensure that the system is capable of handling low-quality scans, distorted text, or multilingual content, thereby allowing the system to process and use a wide range of documents.

In some embodiments, document indexing service 110 comprises section identification service 113. Document indexing service 110 can use the section identification service 113 in connection with performing header or section discovery or otherwise determining the document structure or other document metadata. Section identification service 113 uses the machine-readable text for an input document (e.g., obtained by input document processing service 111) to determine the document structure and other metadata for the input document. In connection with determining the document structure and other metadata for the input document, document indexing service 110 (e.g., section identification service 113) generates or otherwise configures (e.g., populates, updates, etc.) a machine-readable object that is indicative of the document structure and other metadata (e.g., document structure metadata). Examples of the metadata includes a section start location, a section end location, a section identifier, a section type, a section summary, a set of cross-references within the document or a particular section (e.g., inter-document cross references and/or intra-document cross references), an indication of whether the corresponding input document comprises sensitive information, a type of sensitive information comprised, a location of the sensitive information, a document type, a document title, one or more entities associated with the input document (e.g., in a legal context, the entities may be the parties to a contract), a date of the input document (e.g., an effective date of a contract), etc. Various other metadata may be extracted from the machine-readable text for the input document.

In response to determining that an input document (e.g., machine-readable text for the input document) is to be processed, for example, to identify the document structure, section identification service 113 can query a machine learning model, such as an LLM, to parse the machine-readable text to extract section identifiers or headers. In some embodiments, section identification service 113 queries machine learning model using the entire machine-readable text for the input document. In other embodiments, section identification service 113 segments the machine-readable text into chunks (e.g., according to a predefined chunk size, etc.) and iteratively queries machine learning model to process a set of chunks associated with the input document.

In addition, document indexing service 110 can use section identification service 113 to identify sub-sections and various other lower-level sections or segments of text in the hierarchy of the document structure. Section identification service 113 can extract the sub-sections (e.g., sub-section identifiers or sub-headings) and configure the machine-readable object using similar techniques deployed to perform the header discovery (e.g., to parse and extract top-level headers for the input document).

In some embodiments, document indexing service 110 comprises post-processing service 115. Document indexing service 110 can use the post-processing service 115 to post-process the machine-readable object, for example, after the machine-readable object has been updated or populated with document structure information (e.g., the header information, the section identifiers, the sub-section identifiers, the sub-headers, etc.). In some embodiments, post-processing service 115 validates the information comprised in the machine-readable object to ensure that the content is consistent with the corresponding section or sub-section of the input document. Additionally, or alternatively, in some embodiments, post-processing service 115 analyzes the machine-readable object to detect any errors (e.g., syntax errors, formatting errors, etc.) that may have been introduced (e.g., by the section identification service 113 or the LLM queried by section identification service 113). Post-processing service 115 may additionally correct the detected errors, such as by updating the machine-readable object, or provide to a user or other system (e.g., client system 140) a recommended correction(s) to resolve the errors.

Post-processing service 115 can use one or more machine learning models in connection with performing the post-processing of the machine-readable object. In some embodiments, any of the one or more machine learning models implemented to post-process the machine-readable object may be different from the machine learning model implemented (e.g., by section identification service 113) to perform the header discovery, etc.

In some embodiments, post-processing service 115 uses a machine learning model specifically trained for performing the post-processing. Post-processing service 115 may use a particular machine learning model that is specifically trained to identify and/or correct errors in a machine-readable object. For example, the particular machine learning model is trained on a training set of a particular machine-readable type (e.g., a particular schema, format, etc.), or a plurality of different machine-readable types.

In some embodiments, document indexing service 110 comprises model management service 117. Document indexing service 110 can use the model management service 117 to manage one or more machine learning models that are implemented by document indexing service 110, for example, the machine learning model used by section identification service 113 to perform header or document structure discovery, or the machine learning model(s) used by post-processing service 115 to post-process (e.g., to validate and/or to detect and correct errors) the machine-readable object. Managing the one or more machine learning models may include exposing the models or instances or agents of the models to various services within document indexing service 110.

In some embodiments, model management service 117 trains a machine learning model for use by document indexing service 110. For example, model management service 117 can train the machine learning model implemented by post-processing service to identify and/or correct errors.

In some embodiments, document indexing service 110 comprises active measure service 119. Document indexing service 110 can use active measure service 119 to perform various functionality with respect to the input documents (e.g., the machine-readable text for the input documents) based at least in part on the document structure (e.g., the machine-readable object or other indices or mappings generated based on the documents structure). Examples of the various functionality includes: (i) determining cross-referencing within the input documents (e.g., intra-document cross-referencing, inter-document cross-referencing), (ii) identifying related documents among the collection of input documents, (iii) consolidating or aggregating related documents into a single document or representation, (iv) detecting sensitive information such as PII, PHI, etc., and (v) enforcing one or more security policies or access controls with respect to sensitive information when a user or system (e.g., a client system 140) accesses a document comprising the sensitive information.

Administrator system 130 comprises an administrator system for use by an administrator. For example, administrator system 130 comprises a system for communication, data access, computation, etc. An administrator uses administrator system 130 to maintain and/or configure the performance or settings of document indexing service 110 and/or one or more of data stores (e.g., data store 120). For example, an administrator uses administrator system 130 to start and/or stop services on document indexing service 110 and/or data store 120, to reboot data store 120, to install software on document indexing service 110 and/or data store 120, to add, modify, and/or remove data on data store 120, etc. Administrator system 130 communicates with document indexing service 110 and/or data store 120 via a web-interface. For example, administrator system 130 communicates with document indexing service 110 and/or data store 120 via a web-browser installed on administrator system 130. As an example, administrator system 130 communicates with document indexing service 110 and/or data store 120 via an application running on administrator system 130.

In various embodiments, an administrator (or other user associated with a tenant or entity with which the tenant is associated such as a customer) uses administrator system 130 to configure a service provided to a tenant (e.g., an instantiation for an organization associated with a particular collection of input documents, or machine learning model to be deployed). As an example, the administrator uses administrator system 130 to communicate with document indexing service 110 to configure the service provided to the tenant. For example, administrator system 130 may communicate with document indexing service 110 via a business application layer. The business application layer can serve as a gateway via which the administrator may interface to manage, configure, etc. a data layer, a control layer, and/or a business layer of document indexing service 110.

Data store 120 stores one or more datasets. In various embodiments, the one or more datasets comprise human resources data, talent data, performance data, financial data, organizational planning data, contracts, health records, or any other appropriate data. In some embodiments, data store 120 stores one or more datasets for a plurality of tenants. In various embodiments, a tenant comprises an organization such as a company, a government entity, a sub-organization of an organization (e.g., a department), or any other appropriate organization. For example, data store 120 comprises one or more database systems for storing data in a table-based data structure, an object-based data structure, etc. In various embodiments, data store 120 comprises one or more of: a business database system, a human resources database system, a financial database system, a university database system, a medical database system, a manufacturing database system, or any other appropriate system. In some embodiments, data store 120 comprises one or more object-oriented database systems.

According to various embodiments, a user uses system 100 (e.g., a client or terminal, such as client system 140, that connects to document indexing service 110 via network 150) to define business logic and/or to execute such business logic with respect to data (e.g., one or more datasets) stored on data store 120. As an example, a user inputs to client system 140 one or more requests (e.g., a user query) to document indexing service 110 for document indexing service 110 to process an input document, train a machine learning model (e.g., for a particular functionality, such as a post-processing functionality), to perform one or more higher-level functionality with respect to the input document based at least in part on the machine-readable object generated/managed by document indexing service 110. As another example, a user inputs to client system 140 one or more queries to be run against a dataset stored in data store 120.

In some embodiments, input document processing service 111, section identification service 113, post-processing service 115, model management service 117, and active measure service 119, or any subset or combination thereof, can be implemented on a single server or a plurality of servers. For example, input document processing service 111 and section identification service 113 are different modules running on the same server or set of servers.

In some embodiments, the document indexing service 110 can parse machine-readable text for an input document, interpret the machine-readable text, and infer document structure. For example, the document indexing service 110 can infer headers for segments of text based on the context or content of the segment.

In some embodiments, document indexing service 110 leverages the capabilities of an LLM to interpret the machine-readable text and infer sections or headers that may not be explicitly labeled in the input document. This technique enables the system to identify patterns or contextual markers within the text that suggest the presence of logical divisions or implied headings. The LLM processes the content of the text and detects implicit relationships and structures that traditional rule-based systems might overlook.

The LLM implemented by document indexing service 110 to infer document structure for an input document can recognize segments of text that, while lacking explicit headers, display contextual or linguistic cues indicative of a distinct section. For example, the LLM may analyze text transitions, shifts in subject matter, or changes in formatting, such as the presence of bullet points, numbered lists, or bolded phrases, to infer where a new section begins. Based on this analysis, the LLM can generate a suitable header that encapsulates the theme or content of the identified segment, thereby enriching the document's structural representation.

In some embodiments, document indexing service 110 system uses an LLM to identify cross-references within the text, which can serve as indirect indicators of section boundaries or relationships. For instance, if a segment of text refers to “the provisions of Section 12,” the LLM can infer that the preceding or following text likely corresponds to Section 12, even if no explicit header is present. By using these references, the system can create a more coherent and navigable document structure. Additionally, the LLM can generate cross-references for inclusion in the machine-readable object, linking related sections for improved accessibility and usability.

To further refine its interpretations, the system may be configured to prompt the LLM with specific queries or instructions tailored to the context of the document. For instance, the system can ask the LLM to generate headers for unlabeled text based on its semantic content or to classify segments according to predefined categories. The system can thus cause the LLM to extract meaningful structural elements from a wide variety of documents, even those with inconsistent formatting or missing labels.

In some embodiments, document indexing service 110 can use an LLM to infer a context or content of a section of text. For example, document indexing service 110 can cause the LLM to generate summaries of the contents for various sections or segments of text. An illustrative example of a prompt that document indexing service 110 may provide to the LLM includes: “Below is a section of text from a legal contract. The section has the header” {Text}“Generate a concise summary of the kind of information the reader can expect to find in the text, without preamble or extraneous explanation.”

Document indexing service 110 can implement a similar post-processing technique for post-processing inferred document structure information. For example, in cases where the inferred headers or sections require validation, the system incorporates mechanisms deployed by post-processing service 115 for review and refinement of the document structure information comprised in the machine-readable object. Post-processing service 115 can cross-check the inferred headers against other parts of the document to confirm their relevance and accuracy. For example, if the LLM generates a header for a segment discussing “Terms and Conditions,” post-processing service 115 may verify (e.g., cause another LLM to verify) that the surrounding text aligns with this theme. If discrepancies are detected, the system can reprocess the segment or seek manual confirmation to ensure the inferred structure is accurate.

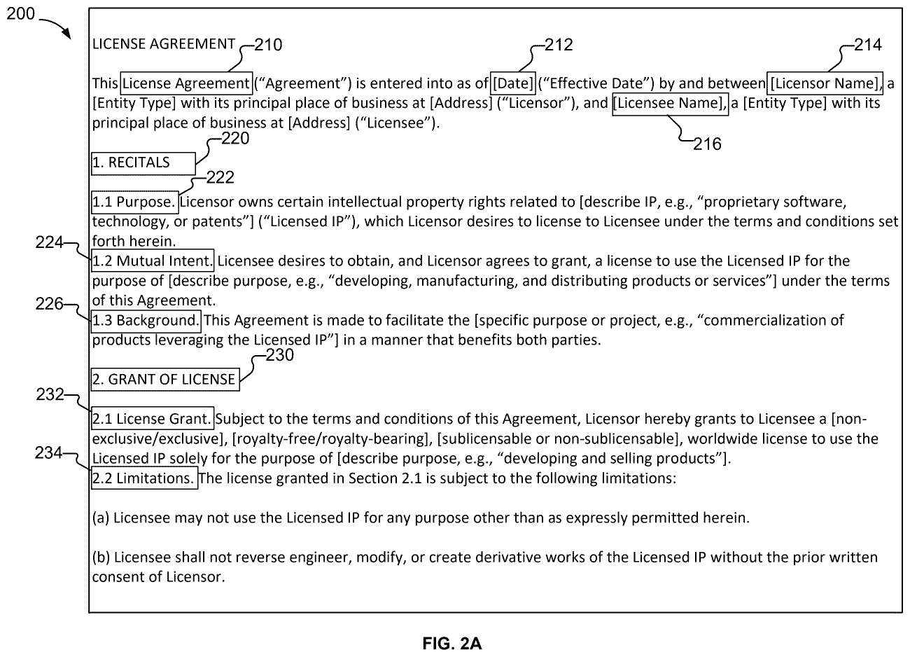

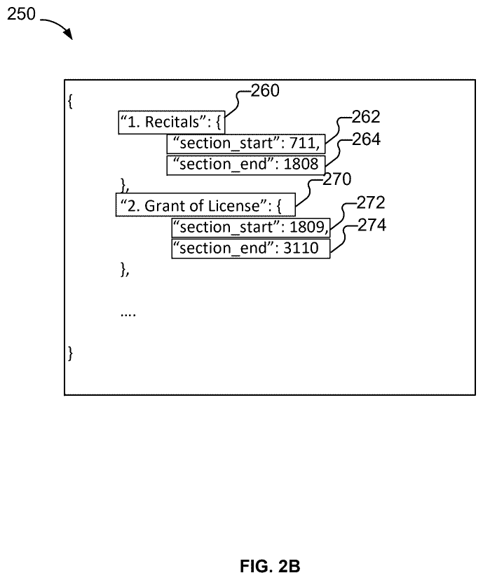

FIG. 2A is an example of an input document according to various embodiments. FIG. 2B is an example of at least part of a machine-readable object generated based at least in part on the input document.

In some embodiments, the system implements the automatic understanding of text documents. According to various embodiments, the technique implemented by the system begins with the extraction of major section headers of the document, which itself yields a high-level understanding. Locating these headers in the text then lends to an ability for the system to segment the text by sections, which enables the system to implement the subsequent discovery of subsections, eventually generating a hierarchy resembling the document's table of contents.

In some embodiments, the system discovery of document structure has direct implications on retrieval augmented generation (RAG). Related art techniques embed fixed-sized text chunks that can lead to splitting of otherwise coherent texts (e.g. a paragraph). In contrast, by using the segmentation implemented according to various embodiments, the system can avoid this problem. Accordingly, the system can process input documents in a manner with improved relevance in retrieval. Additionally, the system can summarize the content of each section and subsection. The system can generate indices at the level of sections and subsections, or even lower-level sub-sections, thus leading to a variation of hierarchical RAG.

In some embodiments, the system performs header discovery with respect to an input document based at least in part on obtaining machine-readable text for the input document, querying a machine learning model (e.g., an LLM) to process the machine-readable text to identify and extract headers, and to generate/update a machine-readable object that indicates the document structure. The machine-readable object may be generated according to a predefined format or schema. For example, the machine-readable object may be a JSON object, a YAML object, an XML object, etc. Various other schemas may be implemented.

In the example shown in FIG. 2A, the system processes (e.g., causes an LLM to process) machine-readable text for input document 200 to extract headers. Input document 200 comprises a set of headers, including top-level header 220 and top-level header 230. Input document 200 further comprises a series of sub-headers, including sub-headers 222, 224, and 226 for the section of text associated with top-level header 220, and sub-headers 232 and 234 for the section of text associated with top-level header 230.

In some embodiments, the system may extract additional metadata from input document 200. For example, input document 200 includes an agreement title or type 210, a date 212, and entity identifiers 214 and 216. In a legal context, entity identifiers 214 and 216 may indicate the entities or persons that are parties to the agreement. The system can extract (e.g., can query the LLM to extract) this additional metadata, which can be stored in the machine-readable object and used in connection with document identification (e.g., to associate the machine-readable object with the input document) and in connection with advanced functionality such as inter-document cross-referencing discovery or sensitive information discovery.

In the example shown in FIG. 2B, machine-readable object 250 comprises information indicative of the document structure for input document 200. The system generates or updates/populates machine-readable object 250 in response to processing input document 200. For example, the system can query an LLM to automatically populate machine-readable object 250 with the extracted document structure and additional metadata. The machine-readable object 250 may be generated according to a predefined definition, format, and/or schema. For example, the machine-readable object 250 can be configured in a machine-readable format such as JSON, XML, or YAML. Various other types of machine-readable format may be implemented.

Referring to FIGS. 2A and 2B, the system configures machine-readable object 250 to comprise the document structure, including an indication of headers extracted from the input document (e.g., the machine-readable text for the input document). For example, machine-readable object 250 comprises a first header 260 corresponding to top-level header 220 extracted from input document. As another example, machine-readable object 250 comprises a second header 270 corresponding to top-level header 230 extracted from input document. The system may extract additional document structure metadata and include the metadata in machine-readable object 250. In the example shown, machine-readable object 250 comprises (i) a start location 262 and an end location 264 for a section of input document text associated with first header 260, and (ii) a start location 272 and an end location 274 for a section of input document text associated with second header 270. The start location and end locations may be defined according to a character count from the beginning of the machine-readable text for the input document. In some embodiments, the system uses the document structure metadata, namely the start location and end location metadata, to parse the machine-readable document into segments of text respectively corresponding to sections of the input document. These segments of text can be separately/individually processed to identify further document structure information, such as sub-headers, intra-document cross-referencing, etc.

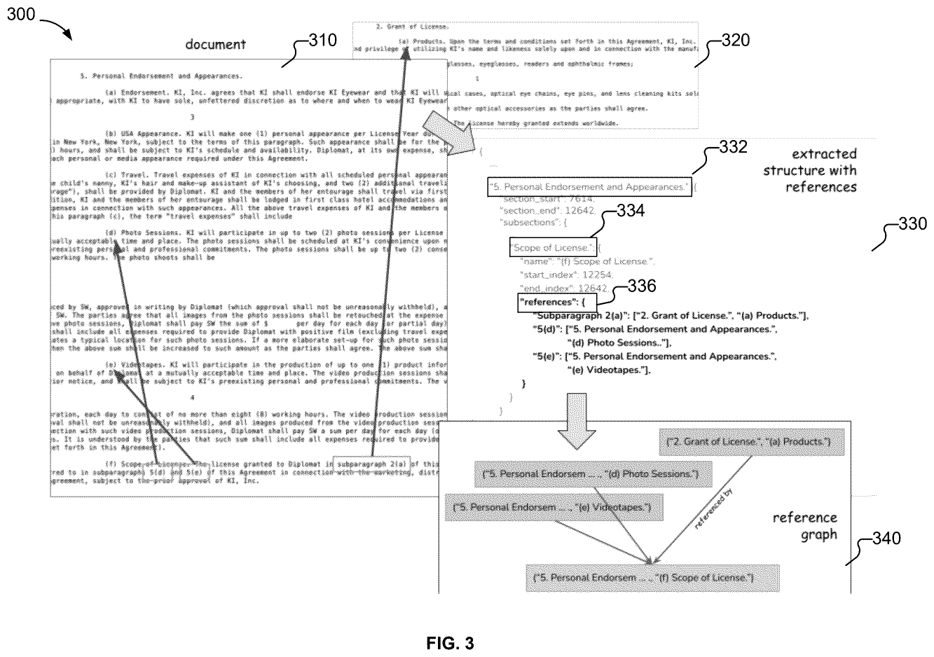

FIG. 3 is an example of performing sub-header discovery for an input document based at least in part on a machine-readable object for the input document according to various embodiments.

The system can apply a deeper analysis to the contents of sections or sub-sections, leading to a higher resolution document structure, which can enable other applications and functionality for using or processing the input documents. For example, in place of summarization, the system can identify (e.g., query the LLM to identify) references to other places in the document, e.g. “ . . . as seen in Sec. 2b”. By resolving the identified references, the system can extract a reference graph that can be used to assist users to quickly find the referred content.

In addition to, or as an alternative to, the summarization or reference-finding function, the system can implement one or more other independent functions to sections or sub-sections of the input document (e.g., the corresponding machine-readable text for the section, etc.) to extract different insights.

According to various embodiments, the system can perform one or more functions with respect to the input document (e.g., the machine-readable text) in matches (e.g., each available function is applied to the entire document). However, in other embodiments, the system can leverage the document structure and a (hierarchical) RAG index to perform a dynamic, query-driven execution of an available function. The system leverages an LLM (e.g., LLM agents) and a predefined set of analysis functions that services (e.g., the LLM agents) can utilize.

In the example shown in FIG. 3, a text segment 310 for a particular section of an input document can cross reference a part of a text segment 320 for another particular section of the input document. Additionally, a text segment 310 for a particular section of text may include cross-references across sub-sections within the particular section. For example, as illustrated, sub-section 5(f) cross-references sub-sections 5(d) and 5(e).

The system generates machine-readable object 330 based at least in part on the analysis of the input document. As shown, the machine-readable object 330 is configured to comprise document structure information. Machine-readable object 330 comprises an indication that the input document includes a header 332 for section 5 (e.g., “Personal Endorsement and Appearances”). Machine-readable object 330 may also include an indication of sub-sections within the section associated with header 332. For example, machine-readable object 330 comprises a sub-section indication 334 that the section comprises a sub-section indication 334 (e.g., the sub-header) corresponding to sub-section 5(f) in the section associated with header 332. In connection with sub-section indication 334, machine-readable object 330 includes additional metadata (e.g., document structure information), including a location of the sub-section (e.g., a start location and an end location), a name of the sub-section, a type of sub-section, and cross references (e.g., inter-document cross-references, intra-document cross-references, etc.), etc. For example, machine-readable object 330 includes cross-references information 336 indicating cross-references that are provided by the machine-readable text for the particular sub-section.

In some embodiments, after processing the input document to identify cross-references within the input document (or a particular section of the input document), the system can generate a reference graph 340 that includes a graph or mapping of all cross-reference associations within the input document (or the particular section of the input document).

FIG. 4 is a flow diagram of a method for obtaining an output object representing an input document according to various embodiments. According to various embodiments, process 400 is implemented at least in part by system 100 of FIG. 1.

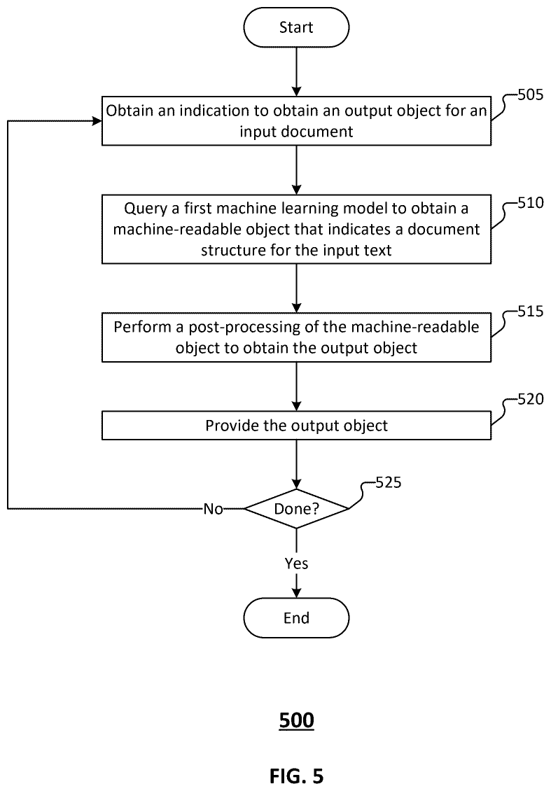

At 405, the system obtains input text for an input document. The input document may be a document type among a set of various document types. For example, the input document may be non-machine-readable and otherwise unstructured. As an illustrative example, the input document may be in .pdf format. Obtaining the input text may include converting the input document to machine-readable text. In some embodiments, the system performs an optical character recognition (OCR) with respect to the input document to obtain machine-readable text. Various OCR techniques may be implemented. In some embodiments, process 400 invokes process 600 in connection with obtaining the input text. At 410, the system obtains an output object for the input document. In some embodiments, the output object is a machine-readable object that indicates a document structure. The output object may include section identifiers, headers, intra-document cross references, a document identifier (e.g., a title, a date, one or more organizations associated with the document, such as parties to a contract, etc.), and inter-document cross references, etc. The system obtains the output object based at least in part on the input text. In some embodiments, the system obtains the output object by invoking process 500 of FIG. 5. For example, the system can process the input text (e.g., machine-readable text) to obtain the output object. At 415, the system provides the output object. In some embodiments, the system provides the output object to a system, service, or process that invoked process 400. At 420, a determination is made as to whether process 400 is complete. In some embodiments, process 400 is determined to be complete in response to a determination that no further input documents are to be processed, no further output objects are to be obtained, an administrator indicates that process 400 is to be paused or stopped, etc. In response to a determination that process 400 is complete, process 400 ends. In response to a determination that process 400 is not complete, process 400 returns to 405.

FIG. 5 is a flow diagram of a method for obtaining a machine-readable object associated with an input document according to various embodiments. According to various embodiments, process 500 is implemented at least in part by system 100 of FIG. 1. In some embodiments, process 500 is invoked by another system, service, or process. For example, process 500 is invoked by process 400 of FIG. 4 (e.g., at 410).

At 505, the system obtains an indication to obtain an input object for an input document. The system may obtain the indication in connection with process 500 being invoked, such as by process 400. The indication may include the input document or an indication and/or location for the input document. At 510, the system queries a first machine learning model to obtain a machine-readable object that indicates a document structure for the input text. In some embodiments, the first machine learning model is an LLM. However, various other types of models may be implemented. The query may include a prompt to the first machine learning model to generate a machine-readable object (or to update an existing machine-readable object for the input document) according to a predefined format and/or syntax. For example, the system may request that the first machine learning model process the machine-readable text and indicate the structure of the machine-readable object being requested. In some embodiments, the query to obtain the machine-readable object includes at least a subset of the machine-readable text or includes a pointer of the subset of the machine-readable text. The query may request the first machine learning model to determine a document structure for the input document based on the machine-readable text. For example, the system requests that the first machine learning model generates the machine-readable object to indicate a set of section identifiers or headers. The system may also request that the first machine-learning model determine (and indicate in the machine-readable object) any sub-sections and cross references within the sections defined by the section identifiers or headings. The predefined format and/or syntax may be in a machine-readable format, such as JSON, XML, or YAML, etc. In some embodiments, process 500 invokes process 700 and/or process 800 in connection with obtaining the machine-readable object. An example of a prompt used by the system to query the LLM includes: “Consider the following except of text . . . {text}, list all main section headers found in the text, pay attention to any numberings or prefixes. Return the headers in a JSON-formatted list.” In some embodiments, the following are examples of prompts that are used to query the LLM to generate the machine-readable object (e.g., the JSON object):

```
  ***
  Consider the following text excerpt:
  text: ‘‘‘{text}
  ‘‘‘
  List all main section headers found in the text, pay attention to any numberings or prefixes.
  Return the headers in a JSON-formatted list.
  ANS:
  ***
For generating subsection headers:
  ***
  The following text is a section of a legal contract, and the section header is is \″{TITLE}\″.
  text: ‘‘‘{TEXT}
  ‘‘‘
  List all sub-headers found within the section of text. Give your answer as a JSON list, with no
  additional explanation or preamble.
  ***
```

Note these are specific to legal contracts, but can be adapted easily for other types of documents. The fields in braces are placeholders for actual text and title of the document. So as the each ‘chunk’ of the doc is processed, that chunk of raw text will take the place of {TEXT} to form the actual prompt submitted to the LLM.

At 515, the system performs a post-processing of the machine-readable object to obtain the output object. In some embodiments, the system post-processes the machine-readable object to validate the sections (e.g., the section identifiers and/or headers) and/or sub-sections within the input document. For example, the system validates that the headers for each section comprised in the machine-readable object appears in the input document (e.g., the machine-readable text). As another example, the system validates that the headers for each section comprised in the machine-readable object is an accurate representation of the corresponding text segment for the associated section (e.g., the first machine learning model either extracted or inferred a header or section identifier based on the text segment for the associated section. In some embodiments, process 500 invokes process 900 and/or process 1000 in connection with post-processing the machine-readable text. At 520, the system provides the output object. In some embodiments, the system provides the output object to the system, service, or process that invoked process 500 (e.g., 410 of process 400). At 525, a determination is made as to whether process 500 is complete. In some embodiments, process 500 is determined to be complete in response to a determination that no further input documents are to be processed, no further output objects are to be obtained, an administrator indicates that process 500 is to be paused or stopped, etc. In response to a determination that process 500 is complete, process 500 ends. In response to a determination that process 500 is not complete, process 500 returns to 505.

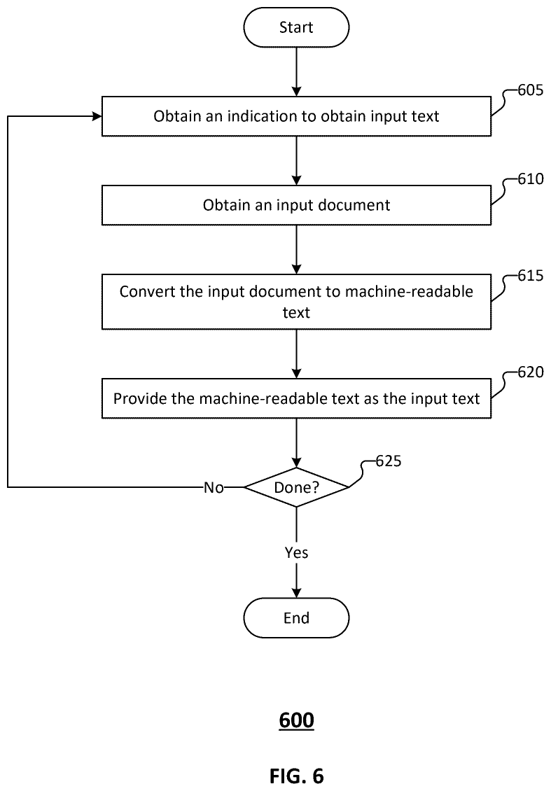

FIG. 6 is a flow diagram of a method for obtaining machine-readable text for an input document according to various embodiments. According to various embodiments, process 400 is implemented at least in part by system 100 of FIG. 1. In some embodiments, process 600 is invoked by another system, service, or process. For example, process 600 is invoked by process 400 of FIG. 4 (e.g., at 405). Process 600 can be invoked to pre-process an input document before processing the input document text to obtain a machine-readable object indicating the document structure, etc.

The system begins its operation by receiving input documents, which may originate from a variety of sources and formats. These documents can include scanned images, PDFs, text files, or other electronic document types. Depending on the application, the input documents may be uploaded manually by a user, received via automated workflows, or retrieved from a connected repository or database. The system can be configured to accommodate documents with varying levels of complexity, from simple, text-heavy files to highly formatted documents with embedded images, tables, or annotations.

Upon receiving the input document (or an indication to obtain a machine-readable object for the input document), the system initiates a pre-processing phase to ensure the document is in a format suitable for subsequent analysis. For image-based or non-text formats, such as scanned PDFs, the system employs OCR technology to convert the document's visual content into machine-readable text. The OCR process identifies and extracts textual elements from the document's layout, transforming them into a structured digital format. This stage may involve advanced OCR techniques capable of handling low-quality scans, distorted text, or multilingual content, ensuring the system can process a wide range of documents effectively.

In addition to OCR, the system may implement other text conversion mechanisms depending on the format of the input document. For example, native digital documents such as text-based PDFs or Word files may not require OCR and can be directly parsed to extract their textual content. During this process, the system may account for any embedded metadata, annotations, or formatting elements that could influence the document's structure or interpretation. This ensures that the conversion is comprehensive and preserves all relevant information for downstream processing.

The machine-readable text obtained during pre-processing is structured into a digital format suitable for input into machine learning models. The system may standardize the text by removing artifacts such as page numbers, watermarks, or extraneous symbols that could interfere with subsequent analysis. Additionally, the text may be normalized to address inconsistencies in font styles, capitalization, or spacing. The resulting machine-readable text can thus serve as a clean and organized representation of the input document, ready for processing by the system's document structure analysis capabilities, such as for obtaining the corresponding machine-readable object as described in connection with FIG. 5.

In some embodiments, the pre-processing phase is critical to the system's overall functionality, as it ensures that all input documents, regardless of their original format or quality, are transformed into a standardized textual representation. By leveraging robust OCR and text conversion technologies, the system lays the groundwork for accurate and efficient extraction of document structures, facilitating the identification of headers, sections, and other key components in subsequent stages.

Returning to the illustrated example, at 605, the system obtains an indication to obtain input text. For example, the system receives an input document or an indication of the input document (e.g., an input document identifier and/or location) in connection with the indication that input text is to be obtained. At 610, the system obtains an input document. For example, the system obtains the input document comprised or indicated in the indication to obtain the input text. At 615, the system converts the input document to machine-readable text. In some embodiments, the system implements the OCR and/or other text conversion mechanisms to obtain the machine-readable text based on the input document. At 620, the system provides the machine-readable text as the input text. For example, the system provides the machine-readable text to the system, service, or process that invoked process 600 (e.g., to 405 of process 400). At 625, a determination is made as to whether process 600 is complete. In some embodiments, process 600 is determined to be complete in response to a determination that no further input documents are to be processed, no further machine-readable text is to be obtained, an administrator indicates that process 600 is to be paused or stopped, etc. In response to a determination that process 600 is complete, process 600 ends. In response to a determination that process 600 is not complete, process 600 returns to 605.

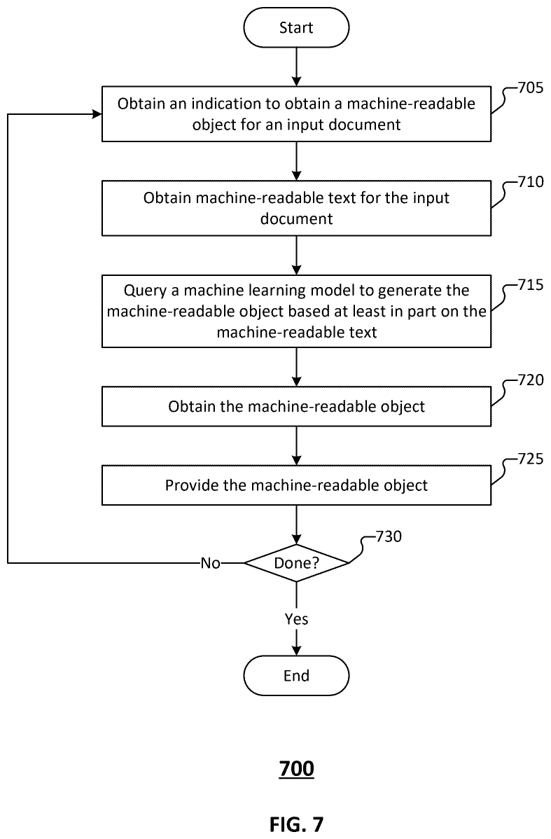

FIG. 7 is a flow diagram of a method for obtaining machine-readable object for an input document according to various embodiments. According to various embodiments, process 700 is implemented at least in part by system 100 of FIG. 1. In some embodiments, process 700 is invoked by another system, service, or process. For example, process 700 is invoked by process 400 of FIG. 4 (e.g., at 410) and/or process 500 of FIG. 5 (e.g., at 510).

In some embodiments, process 700 is implemented in connection with identifying section identifiers and/or top-level headers in the input document (e.g., in the machine-readable text corresponding to the input document). The system may implement process 700 to identify and extract the section information (e.g., section identifiers, top-level headers, associated text segments for sections, an indication of a start location(s) for a section(s), and indication of an end location(s) for a section(s), etc.).

Once the input document has been converted into machine-readable text, the system proceeds to identify and extract sections or headers. According to various embodiments, this process begins by querying a machine learning model, such as an LLM, which is specifically tasked with analyzing the text for structural elements. The LLM may be a generic LLM (e.g., ChatGPT, Gemini, Llama, Grok, etc.) or an LLM specifically trained to parse machine-readable text to identify/extract text structure information. The system generates a prompt for the LLM, instructing it to recognize and extract headers or section titles from the machine-readable text. These headers serve as markers that define the document's structure and hierarchy, providing a foundation for subsequent organization and processing.

For lengthy or complex documents, the system segments the machine-readable text into smaller portions, often based on a predefined size. Each segment is then individually processed by the LLM, which analyzes the text to identify potential headers and/or other section information. By breaking the text into manageable segments, the system ensures that the LLM can focus on smaller, contextually relevant portions, thereby improving the accuracy and efficiency of header extraction. The system iteratively processes these segments, prompting the LLM to continue its analysis until the entire document has been examined. In some embodiments, the system can process a plurality of these segments in parallel, such as by querying a plurality of instances of the LLM.

According to various embodiments, during this process, the system incorporates mechanisms to handle cases where the LLM fails to identify any headers within a specified portion of the document. For example, if the model does not recognize headers within a threshold number of segments or a defined percentage of the document, the system may classify the input document as unstructured. This classification can allow the system to filter out documents that lack meaningful structure, thereby optimizing resource allocation and maintaining the integrity of downstream operations.

Once headers are identified, the system formats the extracted information into a machine-readable output object, such as JSON, XML, or YAML. This output object not only lists the headers but may also include metadata such as the position or character count where each header begins and ends within the document. This metadata enables the system to define precise boundaries for each section, which can be used for further parsing or analysis. By maintaining a structured and standardized representation of the document's hierarchy, the system lays the groundwork for more advanced processing tasks, such as extracting sub-headers or cross-referencing related sections.

According to various embodiments, in scenarios where errors or ambiguities arise, the system employs validation and correction techniques to refine the extracted headers. For instance, the system may cross-check the headers against the original text to confirm their accuracy. Additionally, it can detect inconsistencies or missing headers by analyzing section numbering or other contextual clues. If discrepancies are found, the system may reprocess the relevant portions of text or seek user input (e.g., prompt a user via a client system) to resolve ambiguities. These validation measures ensure that the identified headers accurately reflect the document's intended structure, providing a reliable basis for further analysis and application.

According to various embodiments, the system implements process 700 to identify and extract sections or headers from a wide variety of input documents. This process not only organizes the document's content but can also enable a range of downstream applications, such as indexing, summarization, and cross-referencing, which often depend on a clear and accurate representation of the document's structure.

Returning to the illustrated example, at 705, the system obtains an indication to obtain a machine-readable object for an input object. At 710, the system obtains a machine-readable text for the input document. The system can retrieve the machine-readable text from storage or the system can invoke process 600 in connection with obtaining the machine-readable text. At 715, the system queries a machine learning model to generate the machine-readable object based at least in part on the machine-readable text. At 720, the system obtains the machine-readable object, for example, from the machine learning model. For example, the system obtains the machine-readable object from the first machine learning model. The system may additionally post-process the machine-readable object to correct any errors introduced by the first machine learning model (e.g., syntax errors, missing section identifiers or headers, missing sub-sections, etc.). At 725, the system provides the machine-readable object. For example, the system provides the machine-readable object to a system, service, or process that invoked process 700. At 730, a determination is made as to whether process 700 is complete. In some embodiments, process 700 is determined to be complete in response to a determination that no further input documents are to be processed, no further machine-readable objects are to be obtained, none of the input documents processed corresponds to a structured document, an administrator indicates that process 700 is to be paused or stopped, etc. In response to a determination that process 700 is complete, process 700 ends. In response to a determination that process 700 is not complete, process 700 returns to 705.

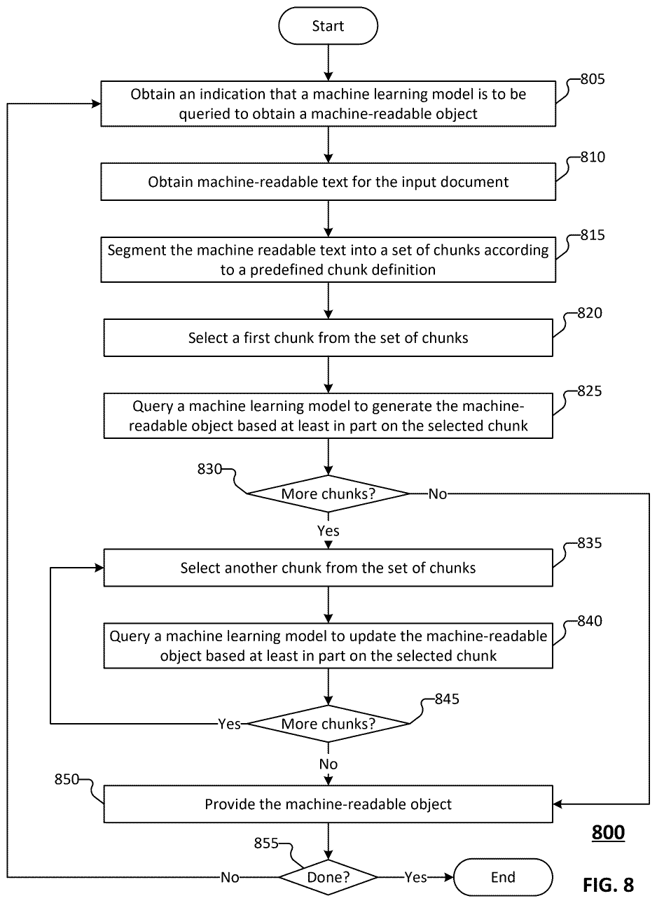

FIG. 8 is a flow diagram of a method for obtaining machine-readable object for an input document according to various embodiments. According to various embodiments, process 800 is implemented at least in part by system 100 of FIG. 1. In some embodiments, process 800 is invoked by another system, service, or process. For example, process 800 is invoked by process 400 of FIG. 4 (e.g., at 410), process 500 of FIG. 5 (e.g., at 510), and/or process 700 of FIG. 7 (e.g., at 715).

In some embodiments, process 800 is implemented in connection with identifying section identifiers and/or top-level headers in the input document (e.g., in the machine-readable text corresponding to the input document) in lengthy documents, such as documents exceeding a threshold size (e.g., character count, page count, etc.). In some embodiments, process 800 can be implemented for all input documents. The system may implement process 800 to identify and extract the section information (e.g., section identifiers, top-level headers, associated text segments for sections, an indication of a start location(s) for a section(s), and indication of an end location(s) for a section(s), etc.).

At 805, the system obtains an indication that a machine learning model is to be queried to obtain a machine-readable object. At 810, the system obtains the machine-readable text for the input document. At 815, the system segments the machine-readable text into a set of chunks according to a predefined chunk definition. For example, the system segments the machine-readable text into a set of chunks having a same predefined size (e.g., except for a last chunk which may be smaller than the other chunks). Various types of predefined sizes may be implemented, such as a predefined character count, a predefine number of paragraphs, a predefined number of pages, etc. At 820, the system selects a first chunk from the set of chunks. At 825, the system queries a machine learning model to generate the machine-readable object based at least in part on the selected chunk. At 830, the system determines whether another chunk is to be processed. For example, the system determines whether the set of chunks comprises a plurality of chunks. In response to determining that no further chunks are to be processed (e.g., that the set of chunks does not comprise any other chunks), process 800 proceeds to 850. Conversely, in response to determining that another chunk is to be processed, process 800 proceeds to 835. At 835, the system selects another chunk from the set of chunks. At 840, the system queries a machine-learning model to update the machine-readable object based at least in part on the selected chunk. For example, the system requests the machine-learning model to process the selected chunk, identify sections (e.g., section identifiers, headers, etc.) in the selected chunk, and update the machine-readable object for the input document to include an indication of such identified sections. At 845, the system determines whether another chunk is to be processed. For example, the system determines whether the set of chunks comprises another chunk that has not yet been processed (e.g., for which section information has been extracted). In some embodiments, the system determines whether another chunk is to be processed based on a determination of whether the input document is a structured document. For example, the system may determine that the input document is unstructured if a threshold amount of the input documents (e.g., a predefined threshold number of chunks) have been processed and no sections have been identified. If the system determines that the input document is unstructured, process 800 may end or proceed to 850. In response to determining that another chunk is to be processed, process 800 returns to 835 and process 800 iterates over 835-845 until the system determines that no further chunks are to be processed. In response to determining that no further chunks are to be processed, process 800 proceeds to 850. At 850, the system provides the machine-readable object. For example, the system provides the machine-readable object to a system, service, or process that invoked process 800. At 855, a determination is made as to whether process 800 is complete. In some embodiments, process 800 is determined to be complete in response to a determination that no further input documents are to be processed, no further machine-readable objects are to be obtained, an administrator indicates that process 800 is to be paused or stopped, etc. In response to a determination that process 800 is complete, process 800 ends. In response to a determination that process 800 is not complete, process 800 returns to 805.

According to various embodiments, after generating the machine-readable object, the system initiates a post-processing phase to ensure the accuracy, completeness, and integrity of the extracted information. Post-processing the machine-readable object may be beneficial because errors or inconsistencies can arise during the extraction process, particularly when machine learning models such as LLMs interpret complex or ambiguous text. In some embodiments, the post-processing comprises a series of automated and, in some cases, semi-automated operations to validate and refine the output object and its alignment with the original machine-readable text.

In some embodiments, the post-processing of the machine-readable object comprises error correction. The system analyzes (or queries another machine learning model to analyze) the machine-readable object for formatting or syntax errors or inconsistencies that may have been introduced during its generation. For instance, if the machine-readable object is in a structured format such as JSON or XML, the system verifies that the syntax adheres to the predefined schema. In cases where errors are detected, the system applies predefined rules or employs another machine learning model trained specifically to identify and correct such errors. For example, if a header is improperly labeled or the metadata for a section is missing, the system can automatically update the output object to restore compliance with the desired format. In some embodiments, the implementing of the predefined rules may include automatically calling a library of functions. The functions may include manually-defined error corrections (e.g., by a domain expert) based on a predefined set of error corrections.

In some embodiments, in addition to correcting technical errors, the system validates the semantic accuracy of the machine-readable object by cross-referencing it with the original machine-readable text. For instance, the system ensures that every header listed in the machine-readable object corresponds to a section or heading present in the machine-readable text for the input document. If discrepancies are found (e.g., such as a header in the output object that does not appear in the text), the system reprocesses the relevant portions of the document or flags the issue for manual review. This validation process ensures that the structure represented in the machine-readable object accurately reflects the content and/or structure of the input document.

In some embodiments, the system also identifies and resolves missing or misclassified sections by analyzing patterns and contextual clues in the text. For example, if the output object includes headers for sections numbered sequentially (e.g., Section 14 and Section 16) but omits Section 15, the system can examine the corresponding portion of the text to determine whether a header for Section 15 exists. If a header is found, the system updates the machine-readable object to include the missing section. Similarly, if sub-headers or nested sections are identified during this process, the system can integrate them into the hierarchical structure of the machine-readable object, ensuring a comprehensive representation of the document.

In some embodiments, post-processing the machine-readable object comprises querying a machine learning model(s) (e.g., different machine learning model) to validate or refine the results. This secondary machine learning model(s), which may be trained specifically on document formatting or structure, processes the same machine-readable text and compares its findings with the existing machine-readable object. Any discrepancies or improvements identified by the secondary model(s) are incorporated into the machine-readable object, either automatically or with user confirmation. The implementation of a multi-model approach can reduce the likelihood of errors and increase confidence in the system's output.

In some embodiments, the system uses post-processing to enrich the output object with additional metadata. For example, the system may calculate precise character counts to define where each section begins and ends, which can aid in further analysis or indexing. However, in other embodiments, the identification of the character counts demarcating sections within the input document may be obtained by the initial machine learning model such as when the top-level headers are identified.

In some embodiments, the system uses post-processing to identify cross-references or relationships between sections, providing users with a more interconnected view of the document's content. These enhancements can improve the utility of the machine-readable object and/or support downstream applications, such as searchability, redaction, or compliance checking.

In some embodiments, the post-processing of the machine-readable object comprises generating summaries or a set of keywords for the various segments associated with the input document sections. The system can generate an index of keywords.

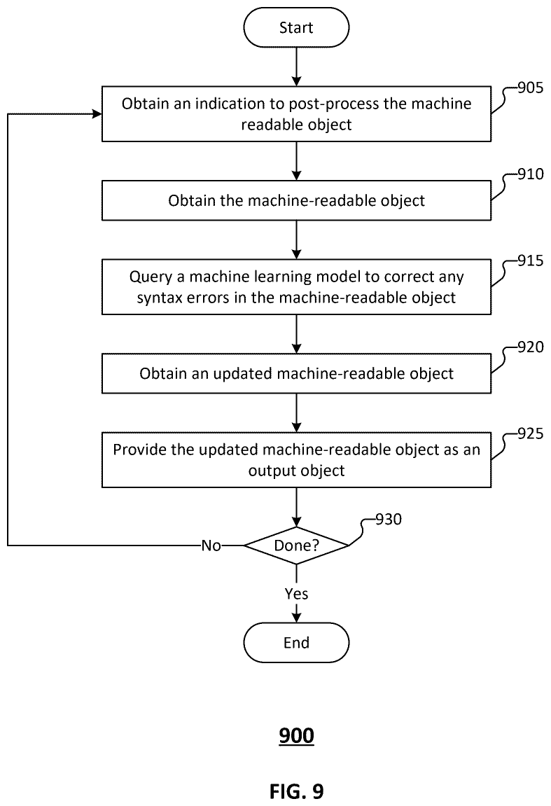

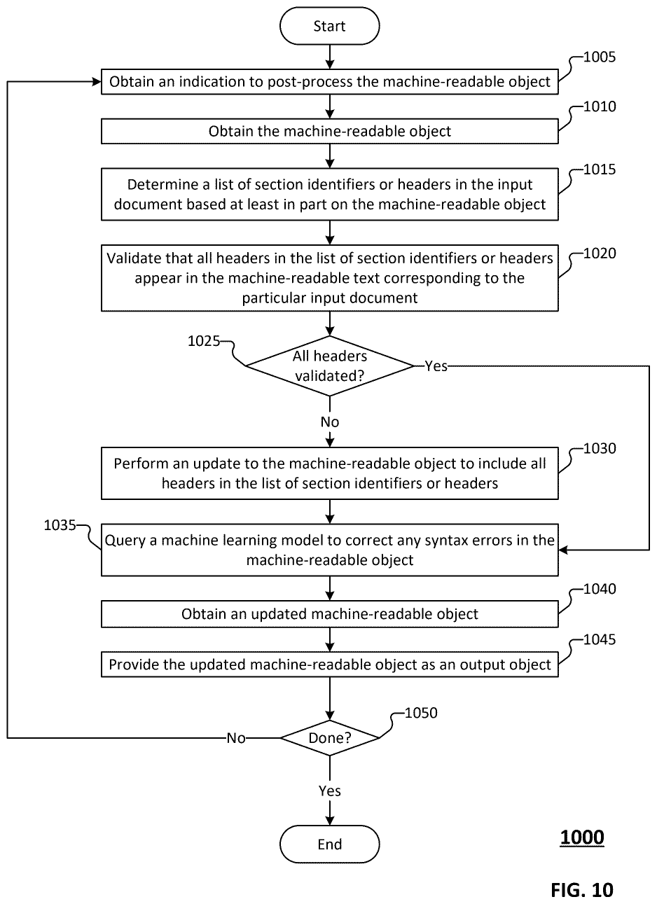

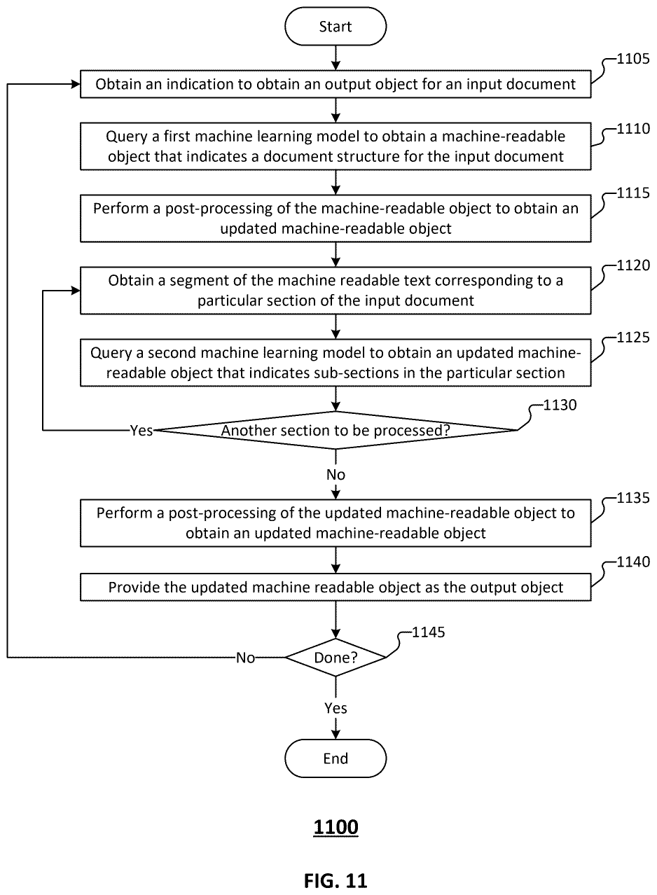

FIG. 9 is a flow diagram of a method for post-processing a machine-readable object for an input document according to various embodiments. According to various embodiments, process 900 is implemented at least in part by system 100 of FIG. 1. In some embodiments, process 900 is invoked by another system, service, or process. For example, process 900 is invoked by process 400 of FIG. 4 (e.g., at 410), process 500 of FIG. 5 (e.g., at 515), process 700 of FIG. 7 (e.g., at 720), process 1000 of FIG. 10 (e.g., 1035), and/or process 1100 of FIG. 11 (e.g., at 1135).

In some embodiments, process 900 is implemented in connection with post-processing a machine-readable object to validate the information comprised in the machine-readable object and/or to identify and correct any errors in the machine-readable object, such as syntax errors introduced by the machine learning model.

At 905, the system obtains an indication to post-process the machine-readable object. At 910, the system obtains the machine-readable object. At 915, the system queries a machine learning model (e.g., a secondary/different machine learning model, etc.) to correct any errors in the machine-readable object, such as syntax errors. At 920, the system obtains an updated machine-readable object (e.g., with the identified errors corrected). At 925, the system provides the updated machine-readable object as an output object. For example, the system provides the machine-readable object to a system, service, or process that invoked process 900. At 930, a determination is made as to whether process 900 is complete. In some embodiments, process 900 is determined to be complete in response to a determination that no further input documents are to be processed, no further machine-readable objects are to be post-processed, an administrator indicates that process 900 is to be paused or stopped, etc. In response to a determination that process 900 is complete, process 900 ends. In response to a determination that process 900 is not complete, process 900 returns to 905.

FIG. 10 is a flow diagram of a method for post-processing a machine-readable object for an input document according to various embodiments. According to various embodiments, process 1000 is implemented at least in part by system 100 of FIG. 1. In some embodiments, process 1000 is invoked by another system, service, or process. For example, process 1000 is invoked by process 400 of FIG. 4 (e.g., at 410), process 500 of FIG. 5 (e.g., at 515), process 700 of FIG. 7 (e.g., at 720), and/or process 1100 of FIG. 11 (e.g., at 1135).

In some embodiments, process 1000 is implemented in connection with post-processing a machine-readable object to validate the information comprised in the machine-readable object and/or to identify and correct any errors in the machine-readable object, such as syntax errors introduced by the machine learning model.

At 1005, the system obtains an indication to post-process the machine-readable object. At 1010, the system obtains the machine-readable object. At 1015, the system determines a list of section identifiers or headers in the input document based at least in part on the machine-readable object. At 1020, the system validates that all headers in the list of sections identifiers or headers appear in the machine-readable text corresponding to the particular input document. In some embodiments, the system can query a secondary/different machine learning model (e.g., a second LLM) to validate the headers or sections identified in the machine-readable object. In some embodiments, the initial machine learning model is configured/prompted to infer section identifiers or headers for portions of the particular document, and the system can validate these inferred headers by querying a secondary/different machine learning model to confirm that the initial inference was accurate. At 1025, the system determines whether all the headers have been validated. In response to determining that all the headers in the list of section identifiers have been validated, process 1000 proceeds to 1035. Conversely, in response to determining that not all headers in the list of section identifiers have been validated, process 1000 proceeds to 1030 at which the system performs an update to the machine-readable object to include all headers in the list of section identifiers or headers. In some embodiments, 1030 is automatically performed when the secondary/different machine learning model is queried to validate the headers, for example, the update to include all correct headers may be implemented contemporaneously with the validation. At 1035, the system queries a machine learning model to correct any syntax errors in the machine-readable object. For example, the system invokes process 900. At 1040, the system obtains an updated machine-readable object. At 1045, the system provides the updated machine-readable object as an output object. For example, the system provides the updated machine-readable object to a system, service, or process that invoked process 1000. At 1050, a determination is made as to whether process 1000 is complete. In some embodiments, process 1000 is determined to be complete in response to a determination that no further input documents are to be processed, no further machine-readable objects are to be post-processed, an administrator indicates that process 1000 is to be paused or stopped, etc. In response to a determination that process 1000 is complete, process 1000 ends. In response to a determination that process 1000 is not complete, process 1000 returns to 1005.

FIG. 11 is a flow diagram of a method for obtaining machine-readable object for an input document according to various embodiments. According to various embodiments, process 1100 is implemented at least in part by system 100 of FIG. 1. In some embodiments, process 1100 is invoked by another system, service, or process. For example, process 1100 is invoked by process 400 of FIG. 4 (e.g., at 410).

In some embodiments, after identifying higher-level headings and defining the main sections of the document, the system further processes the corresponding portions of machine-readable text to identify sub-headers within each section. This hierarchical approach ensures that the document's structure is captured in greater detail, allowing for more nuanced indexing, cross-referencing, and analysis. The system isolates the text associated with each higher-level heading, such as by using the metadata generated during earlier stages to determine the start and end boundaries of the section.

In some embodiments, the system queries a machine learning model, such as an LLM, to analyze these isolated text segments for potential sub-headers. This may include prompting the LLM with instructions to identify natural breaks, thematic shifts, or stylistic indicators within the section that suggest the presence of subheadings. For instance, the LLM might recognize that a portion of the text introduces a new topic, is preceded by formatting such as bold or italicized text, or includes key phrases often used to denote subsections. Based on its analysis, the LLM generates a list of candidate sub-headers, which are then integrated into the document's structural representation. In some embodiments, the machine learning model implemented to identify/extract top-level headers is the same as the machine learning model implemented to identify/extract sub-headers. In other embodiments, the machine learning model implemented to identify/extract top-level headers is different from the machine learning model implemented to identify/extract sub-headers.

As sub-headers are identified, the system may update the machine-readable object to include these additional layers of organization. Each sub-header is linked to its corresponding higher-level heading, preserving the hierarchical relationships within the document. The system also assigns metadata to each sub-header, such as character or word counts indicating its precise location in the text. This metadata not only ensures accurate representation of the document's structure but also enables efficient navigation and further processing of its content.

To ensure accuracy, the system may validate the extracted sub-headers against the original text. For example, the system can implement a similar post-processing technique used to validate the list of top-level headers. In some embodiments, the system confirms (or queries a machine learning model to confirm) that the sub-headers align with the thematic content of their respective sections and that no major topics are overlooked. Additionally, the system can identify gaps or inconsistencies, such as missing sub-headers, by analyzing patterns in the text. For example, if the text includes numbered subsections (e.g., 1.1, 1.2) but skips a number, the system may reanalyze the corresponding portion of the text to determine whether a sub-header was omitted or misclassified. This iterative process ensures that the sub-header extraction is both thorough and reliable.

In some embodiments, the system may identify and extract additional sub-subheaders or further nested levels of organization within the document. This is achieved by repeating the same process for the portions of text associated with the sub-headers, enabling the creation of a multi-layered structural hierarchy. Information (e.g., structure information) for each additional level can be incorporated into the machine-readable object, preserving the input document's full organizational complexity.

Returning to the illustrated example, at 1105, the system obtains an indication to obtain an output object for an input document. At 1110, the system queries a first machine learning model to obtain a machine-readable object that indicates a document structure for the input document. At 1115, the system performs a post-processing of the machine-readable object to obtain an updated machine-readable object. At 1120, the system obtains a segment of the machine-readable text corresponding to a particular section of the input document (e.g., as demarcated using structure information in the generated machine-readable object). At 1125, the system queries a second machine learning model to obtain an updated machine-readable object that indicates sub-sections in the particular section. In some implementations, the first machine learning model and the second machine learning model are the same model. In other implementations, the first machine learning model and the second machine learning model are different. An illustrative example of a prompt used by the system to query the LLM to extract sub-sections includes: “the following text is a section of a legal contract, and the section header is,” {Text}, “list all sub-headers found within the section of text. Give your answer as a JSON list with no additional explanation or preamble.” Another example of a prompt that the system can query the LLM to identify labels for headers includes “consider the following list of headers extracted from an input document.” {headers}“A major section header may start with a number, possibly followed by the name of the section, then the text content of the section. A major section header is also often written in full upper case. For each header given above, determine whether it is a major header, answer Yes/No only with no explanation or preamble. Give your final answer as a JSON object with the headers as keys.” At 1130, the system determines whether another section is to be processed. For example, the system determines whether another section identified in the machine-readable text is to be evaluated for sub-header extraction. In response to determining that another section is to be processed, process 1100 returns to 1120 and process 1100 iterates over 1120-1130 until no further sections are to be processed. In response to determining that no further sections are to be processed, process 1100 proceeds to 1135. At 1135, the system performs a post-processing of the machine-readable object to obtain an updated machine-readable object. For example, the system can invoke process 900, 1000, and/or 1200. At 1140, the system provides the updated machine-readable object as the output object. For example, the system provides the machine-readable object to a system, service, or process that invoked process 1100. At 1145, a determination is made as to whether process 1100 is complete. In some embodiments, process 1100 is determined to be complete in response to a determination that no further input documents are to be processed, no further machine-readable text is to be processed, an administrator indicates that process 1100 is to be paused or stopped, etc. In response to a determination that process 1100 is complete, process 1100 ends. In response to a determination that process 1100 is not complete, process 1100 returns to 1105.

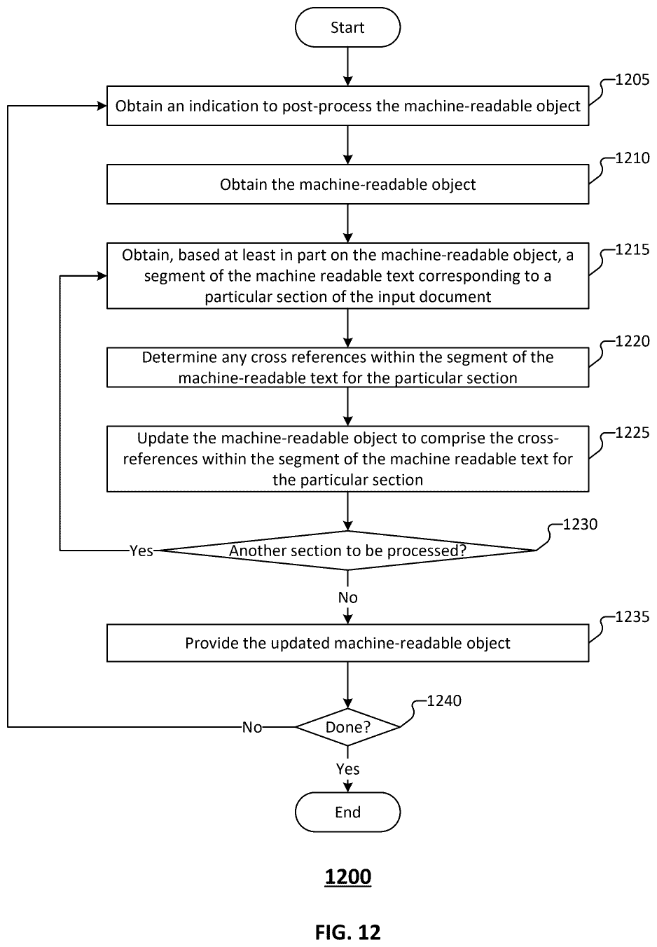

FIG. 12 is a flow diagram of a method for post-processing a machine-readable object for an input document according to various embodiments. According to various embodiments, process 1200 is implemented at least in part by system 100 of FIG. 1. In some embodiments, process 1200 is invoked by another system, service, or process. For example, process 1200 is invoked by process 400 of FIG. 4 (e.g., at 410), process 500 of FIG. 5 (e.g., at 515), process 700 of FIG. 7 (e.g., at 720), and/or process 1100 of FIG. 11 (e.g., at 1135).

In some embodiments, process 1200 is implemented in connection with post-processing a machine-readable object to identify cross-references or other metadata comprised in the input document (e.g., in the machine-readable text for the input document).

The system can identify and index cross-references within an input document by analyzing the machine-readable text for contextual or explicit references between sections. Cross-references can often appear in the form of section numbers, titles, or phrases such as “as discussed in Section 3.2” or “refer to the Terms and Conditions in Section 7.” Using its understanding of language and document structures, the system employs a machine learning model, such as an LLM, to detect and interpret these references. The system (e.g., the LLM) scans the text for patterns or keywords commonly associated with cross-references and maps them to the corresponding sections in the document.

Once the cross-references are identified, the system validates them by checking the existence and accuracy of the referenced sections in the input document's structure. For example, if a cross-reference mentions Section 4.1, the system ensures that a section labeled 4.1 is present in the document. If discrepancies are found, such as a missing or incorrectly numbered section, the system flags the issue for further review or correction. This validation process can ensure the integrity of the document's cross-referencing and prevent errors in the final output.

The system incorporates cross-references into the machine-readable object, enhancing its utility for navigation and analysis. For example, when generating a structured output such as JSON, XML, or Hypertext Markup Language (HTML), the system embeds metadata that links each cross-reference to the specific section it references. These links are represented as pointers or hyperlinks that allow users to directly navigate between related sections of the document. In some embodiments, the hyperlinks are anchored using the metadata associated with each section, such as character offsets or section identifiers, ensuring precise and accurate navigation.

As an illustrative example, for an input document that outlines a complex agreement with multiple interrelated sections, if a section titled “Payment Terms” references “Termination Clauses in Section 12,” the system detects this reference during text processing. In some embodiments, in an output object (e.g., a representation of the input document comprising structure information) generated based on the machine-readable object, the system transforms the text “Termination Clauses in Section 12” into an active hyperlink pointing to the beginning of Section 12. When the document is viewed in a user interface, clicking on the hyperlink would take the user directly to the referenced section, streamlining navigation. This functionality is particularly valuable in lengthy or complex documents, where manual navigation between sections can be time-consuming and error prone.

The system also ensures that cross-referencing is preserved across multiple output formats. For instance, if the output object (e.g., an output document) is generated as an interactive PDF or HTML file, the hyperlinks are rendered visually, making the references clickable. In addition to hyperlinks, the system may generate a cross-reference index, summarizing all references in the document and their targets. This index can serve as a navigational aid, allowing users to see at a glance how different sections relate to one another.

By indexing cross-references and embedding hyperlinks in the output, the system enhances the usability and accessibility of complex documents. Users can seamlessly navigate between interrelated sections, reducing cognitive load and improving efficiency. As an example, this capability may be particularly beneficial in contexts such as legal agreements, technical manuals, or regulatory documents, where understanding the relationships between sections is critical for effective analysis and decision-making.

Returning to the illustrated example, at 1205, the system obtains an indication to post-process the machine-readable object. At 1210, the system obtains the machine-readable object. At 1215, the system obtains, based at least in part on the machine-readable object, a segment of the machine-readable text corresponding to a particular section of the input document. For example, the system can use the structure information in the machine-readable object to determine the start and end of a section, for example, a character count at which the section begins and a character count at which the section ends. At 1220, the system determines any cross references within the segment of the machine-readable text for the particular section. In some embodiments, the system can query a machine learning model to identify cross-references within the section. At 1225, the system updates the machine-readable object to comprise the cross-references within the segment of the machine-readable text for the particular section. At 1230, the system determines whether another section is to be processed. For example, the system determines whether another section identified in the machine-readable text is to be evaluated for cross-reference identification. In response to determining that another section is to be processed, process 1200 returns to 1215 and process 1200 iterates over 1215-1230 until no further sections are to be processed. In response to determining that no further sections are to be processed, process 1200 proceeds to 1235. At 1235, the system provides the updated machine-readable object. For example, the system provides the machine-readable object to a system, service, or process that invoked process 1200. At 1240, a determination is made as to whether process 1200 is complete. In some embodiments, process 1200 is determined to be complete in response to a determination that no further input documents are to be processed, no further machine-readable objects are to be post-processed, an administrator indicates that process 1200 is to be paused or stopped, etc. In response to a determination that process 1200 is complete, process 1200 ends. In response to a determination that process 1200 is not complete, process 1200 returns to 1205.

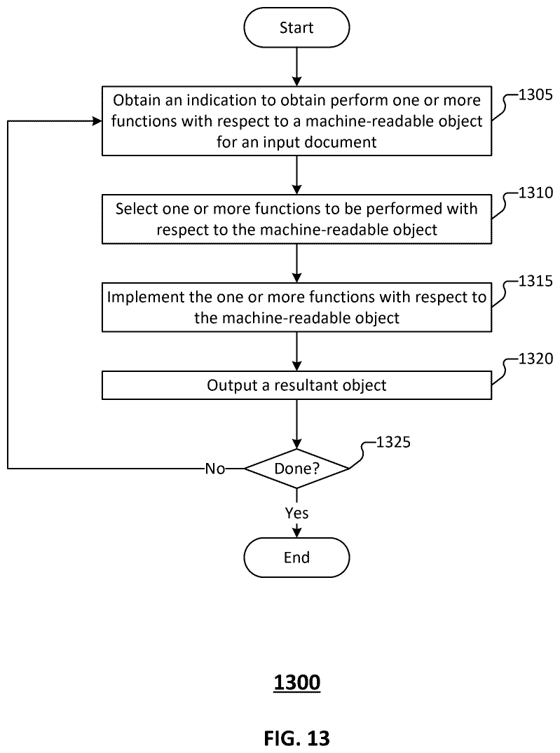

FIG. 13 is a flow diagram of a method for implementing a machine-readable object for an input document in connection with performing a function according to various embodiments. According to various embodiments, process 1300 is implemented at least in part by system 100 of FIG. 1. In some embodiments, process 1300 is invoked by another system, service, or process. For example, process 1300 may be implemented in connection with using the machine-readable object corresponding to an input document for further document analysis or for performing one or more functions.

At 1305, the system obtains an indication to perform one or more functions with respect to a machine-readable object for an input document. As an example, the system may receive a user request to identify related documents, to aggregate a set of input documents into a single document, to enforce a security policy, etc. At 1310, the system selects one or more functions to be performed with respect to the machine-readable object. At 1315, the system implements the one or more functions with respect to the machine-readable object. In some embodiments, the system invokes one or more of processes 1400-1700. At 1320, the system output a resultant object. For example, the system provides a resultant object (e.g., a result of the performing the one or more functions, for example, a representation of the input document) to a system, service, or process that invoked process 1300. At 1300, a determination is made as to whether process 1300 is complete. In some embodiments, process 1300 is determined to be complete in response to a determination that no further input documents are to be manipulated, no further machine-readable objects are to be used, an administrator indicates that process 1300 is to be paused or stopped, etc. In response to a determination that process 1300 is complete, process 1300 ends. In response to a determination that process 1300 is not complete, process 1300 returns to 1305.

In managing complex sets of related documents, a significant challenge lies in effectively navigating and understanding the relationships both within a single document and across multiple documents. These relationships are often defined by cross-references, such as references to sections, clauses, or terms within the same document or citations and connections to other documents in the set. According to various embodiments, the system can address these challenges by generating output representations of related documents that include hyperlinks serving as navigational pointers for these cross-references. This functionality can enhance the accessibility, usability, and coherence of the document set.

In some embodiments, the system begins by analyzing each document individually to identify internal cross-references. The system can use machine-readable text to process/analyze the content to locate references such as section numbers, titles, or specific clauses. The system can leverage machine learning models, such as LLMs, to interpret both explicit and implicit cross-references. Once identified, these references are validated (e.g., by a secondary machine learning model) by confirming that they point to existing sections or elements within the document. The system embeds metadata in the machine-readable object for an input document to map each cross-reference to its corresponding location, enabling seamless navigation.

According to various embodiments, the system examines relationships across the set of related documents. By analyzing contextual or explicit references to other documents, such as “See Amendment 2 for updated terms,” or “Refer to the policies outlined in Document B,” the system identifies and validates cross-references between the documents. The system uses unique identifiers, metadata, and contextual analysis to ensure that these references accurately reflect the relationships between the documents. The system can then (e.g., upon user request) generate a unified output representation where these inter-document cross-references are hyperlinked, creating a connected and navigable document set.

The output generated by the system can take various forms, including interactive digital documents, structured data formats like JSON or XML, or user-friendly interfaces. For example, in a legal context involving a master contract and multiple amendments, the system generates an aggregated output where users can navigate from a clause in the master agreement to the corresponding updates in the amendments via hyperlinks. These links allow users to trace changes and updates efficiently, eliminating the need for manual cross-referencing and reducing the risk of errors. As another example, in a similar legal context involving a master contract and multiple amendments, the system can output a representation of an amended and restated agreement in which all changes to the master contract by the various amendments are committed (or shown as committed) according to a sequence of the amendments (e.g., which can be determined based on an amendment identifier or effective date of the amendments, etc.).

In another example, within a healthcare context, the system may process a set of related documents such as patient medical records, lab reports, and treatment plans. The output consolidates these records and includes hyperlinks for cross-references, such as linking a test result to the corresponding physician's notes or a prescribed medication to its dosage instructions in a treatment plan. This interconnected representation allows healthcare providers to access relevant information instantly, improving decision-making and patient care.

In some embodiments, the hyperlinks are dynamically generated and anchored to precise locations within the documents (e.g., based on the particular cross-referencing identified by the system), ensuring that navigation is accurate and intuitive. For example, users can click on a hyperlink within a clause or section to instantly access the referenced material, whether it is within the same document or in another document in the set (e.g., another document identified as being a related document).

According to various embodiments, by generating output representations with hyperlinked cross-references, the system can transform static and disjointed document collections into interactive, navigable resources. This capability can enhance a user experience when reviewing documents. In addition, this capability can provide a reliable tool for analyzing, interpreting, and managing complex relationships within and across documents.

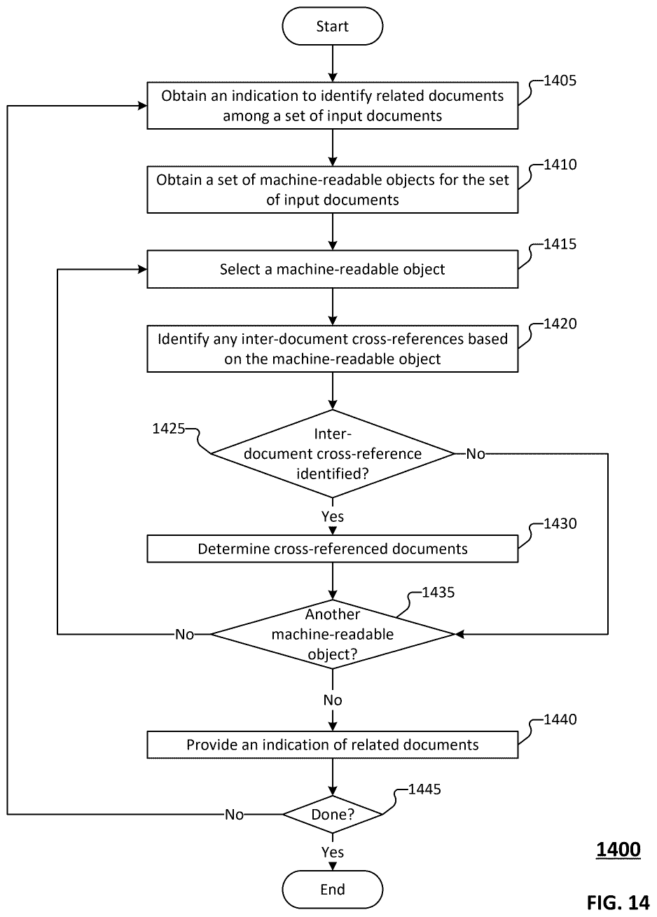

FIG. 14 is a flow diagram of a method for identifying related documents based on machine-readable objects for a set of input documents according to various embodiments. According to various embodiments, process 1400 is implemented at least in part by system 100 of FIG. 1. In some embodiments, process 1400 is invoked by process 1300, such as at 1315.

According to various embodiments, the system is configured to identify, interpret, and associate related input documents by analyzing (e.g., based at least in part on respective machine-readable objects) their content and metadata for contextual and explicit connections. The system processes each document individually, extracting structural elements such as headers, sub-headers, and cross-references, while simultaneously analyzing references to other documents. These references might include citations, cross-references by title, section numbers, or contextual cues that indicate relationships between the documents. The system can leverage machine learning models, such as LLMs, to interpret these connections to establish associations between the documents.

For example, the system might analyze a set of legal documents, such as an initial contract and its amendments, to determine how the documents are interrelated. The system (e.g., the LLM) identifies explicit references, such as “Amendment 1 modifies Section 3 of the Master Agreement,” or implicit relationships, such as similar titles, shared parties, or related content. Based on these references, the system maps the relationships between the documents, creating a network of interconnections. These associations may be validated by ensuring that referenced sections or clauses exist and by verifying that the modifications align with the content of the original document.

At 1405, the system obtains an indication to identify related documents among a set of input documents. For example, process 1400 may be invoked (e.g., automatically) after a set of input documents have been processed/analyzed and corresponding machine-readable objects have been generated. As another example, as each input document is added to a collection and processed, the system can invoke process 1400 to identify or update a mapping of related documents. At 1410, the system obtains a machine-readable object for the set of input documents. At 1415, the system selects a machine-readable object. At 1420, the system identifies any inter-document cross-references based at least in part on the machine-readable object. For example, the system queries a machine learning model to iteratively process sections identified by the machine-readable object to identify inter-document cross-referencing. At 1425, the system determines whether an inter-document cross-reference is identified for the corresponding input object. In response to determining that no inter-document cross-reference is identified, process 1400 proceeds to 1435. Conversely, in response to determining that the system identifies an inter-document cross-reference within an input document, process 1400 proceeds to 1430 at which the system determines cross-referenced documents. For example, the system can update the machine-learning objects for the input documents and the cross-referenced document(s) to include a cross referencing among the related documents. At 1435, the system determines whether another machine-readable object is to be processed. For example, the system determines whether another input document in the set of input documents and corresponding machine-readable object is to be analyzed to identify cross-references. In response to determining that another machine-readable object is to be processed, process 1400 returns to 1415 and process 1400 iterates over 1415-1435 until no further machine-readable objects are to be processed. In response to determining that no further machine-readable objects are to be processed, process 1400 proceeds to 1440. At 1440, the system provides an indication of related documents. For example, the system provides the indication of related documents to a system, service, or process that invoked process 1400. As another example, the system stores the cross-referencing, such as in the respective machine-learning objects and/or in a mapping of related documents. At 1445, a determination is made as to whether process 1400 is complete. In some embodiments, process 1400 is determined to be complete in response to a determination that no further input documents are to be processed, an administrator indicates that process 1400 is to be paused or stopped, etc. In response to a determination that process 1400 is complete, process 1400 ends. In response to a determination that process 1400 is not complete, process 1400 returns to 1405.

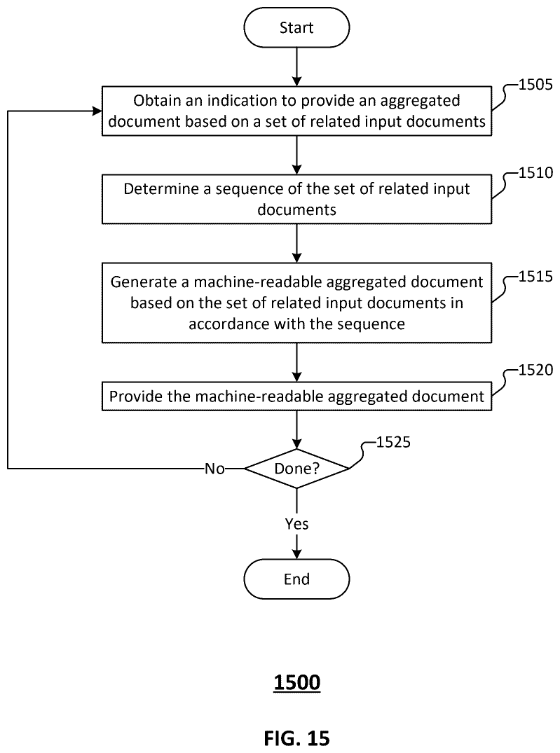

FIG. 15 is a flow diagram of a method for generating an aggregated document based on a set of related documents identified based on machine-readable objects for a set of input documents according to various embodiments. According to various embodiments, process 1500 is implemented at least in part by system 100 of FIG. 1. In some embodiments, process 1500 is invoked by process 1300, such as at 1315.

According to various embodiments, once the associations are established (e.g., once process 1400 has been implemented for a set of input documents), the system can generate an aggregated output that consolidates the related documents into a unified representation. In the case of a contract with multiple amendments, the system resolves the modifications by sequentially applying the changes outlined in each amendment to the original agreement. If a section is amended multiple times across the amendments, the system ensures that the final output reflects the most recent state of that section. For example, if Section 5 of a contract is modified in Amendments 2 and 4, the system incorporates both changes in the correct sequence, ensuring that the final representation accurately reflects the current state of the contract.

In some embodiments, the consolidated output is presented in a machine-readable format or a human-readable document, depending on the use case. For instance, the system might generate an interactive document where users can view the original contract alongside its amendments or navigate directly to the final version of each section. This aggregated output simplifies complex document relationships, providing a clear and comprehensive view of the current state of the agreement.

In a healthcare context, the system can process a set of related documents, such as a patient's medical history, test results, and treatment plans, to generate a consolidated health record. By analyzing and associating documents based on patient identifiers, dates, and referenced treatments or diagnoses, the system creates a unified record that summarizes the patient's history and current health status. For example, the system may integrate chronological notes from multiple physicians, test results from various labs, and medication history into a single document. The output could include a timeline of the patient's health events, a summary of active treatments, and an analysis of historical trends to aid in decision-making.

This ability to consolidate related documents enhances the accessibility and usability of complex document sets. For example, the system provides an aggregated view that reduces redundancy, eliminates confusion from overlapping changes/information, and ensures that users have access to the most up-to-date and relevant information. This functionality can support better decision-making, improve efficiency, and provide a reliable representation of the relationships and current state of the associated documents.

Returning to the illustrated example, at 1505, the system obtains an indication to provide an aggregated document based on a set of related input documents. For example, process 1500 may be invoked (e.g., automatically) after a set of input documents have been processed/analyzed and corresponding machine-readable objects have been generated. As another example, process 1500 may be invoked (e.g., automatically) after a set of input documents have been analyzed and inter-document cross referencing has been identified and/or mapped across the set of input documents. At 1510, the system determines a sequence of the set of related input documents (e.g., based on the inter-document cross-referencing or mapping of related input documents). At 1515, the system generates a machine-readable aggregated document based on the set of related input documents in accordance with the sequence. At 1520, the system provides the machine-readable aggregated document. For example, the system provides the machine-readable aggregated document to a system, service, or process that invoked process 1500. At 1525, a determination is made as to whether process 1500 is complete. In some embodiments, process 1500 is determined to be complete in response to a determination that no further input documents are to be processed, no further aggregated representations are to be generated, an administrator indicates that process 1500 is to be paused or stopped, etc. In response to a determination that process 1500 is complete, process 1500 ends. In response to a determination that process 1500 is not complete, process 1500 returns to 1505.

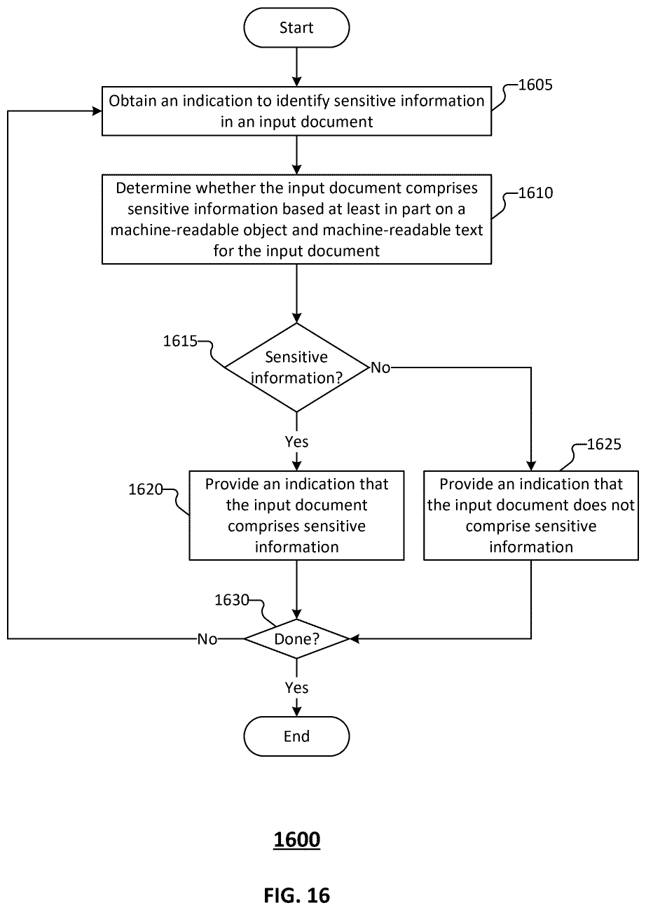

FIG. 16 is a flow diagram of a method for identifying sensitive information in an input document based at least in part on a machine-readable object for the input document according to various embodiments. According to various embodiments, process 1600 is implemented at least in part by system 100 of FIG. 1. In some embodiments, process 1600 is invoked by process 1300, such as at 1315.

The management and processing of sensitive information, such as Personally Identifiable Information (PII) or Protected Health Information (PHI), is a critical challenge across various industries, including healthcare, legal, and finance. Documents containing sensitive data often include explicit or implicit structural markers, such as headers, metadata, or specific text patterns, which can help identify the presence of such sensitive information. In some embodiments, the system is configured to identify sensitive information within documents and enforcing access controls to ensure secure handling of this data.

In some embodiments, the system begins by analyzing the machine-readable text of input documents using machine learning models, such as LLMs, to detect and interpret structural and contextual indicators of sensitive information. The system identifies specific sections or elements, such as headers labeled “Personal Information,” “Health History,” or “Social Security Number,” and uses predefined mappings or trained models to associate these labels with known categories of sensitive data. The system can also interpret textual content to detect sensitive information embedded within sections that may lack explicit labels, such as by implementing pattern recognition for data such as addresses, credit card numbers, or medical diagnoses. Similarly, the system can detect medical terms, diagnosis codes, or treatment details often associated with PHI. The system uses context and predefined rules and/or machine learning models, to ensure accurate identification of sensitive information even in unstructured or loosely formatted text. In some embodiments, in response to identifying sensitive information, the system updates the machine-readable object to include an indication that a particular section comprises sensitive information. The indication may also include an indication of a type of sensitive information comprised in the section.

At 1610, the system obtains an indication to identify sensitive information in an input document. At 1610, the system determines whether the input document comprises sensitive information based at least in part on a machine-readable object and machine-readable text for the input document. For example, the system queries a machine learning model to determine whether the input document (e.g., the machine-readable text) comprises sensitive information and to identify such sensitive information. The system can use the machine-readable object for the input object to identify sections within the input document and the system can process the input document on a section-by-section basis (e.g., the system can iteratively prompt the machine learning model to process the text for a section). At 1615, the system determines whether sensitive information has been identified. In response to determining that sensitive information has been identified, process 1600 proceeds to 1620 at which the system provides an indication that the input document comprises sensitive information. For example, the system provides the indication of sensitive information to a system, service, or process that invoked process 1600. Conversely, in response to determining that sensitive information has not been identified (e.g., that the input document does not comprise sensitive information), process 1600 proceeds to 1625 at which the system provides an indication that the input document does not comprise sensitive information. For example, the system provides the indication that the input document does not comprise sensitive information to a system, service, or process that invoked process 1600. At 1630, a determination is made as to whether process 1600 is complete. In some embodiments, process 1600 is determined to be complete in response to a determination that no further input documents are to be processed, no further input documents are to be evaluated for sensitive information, an administrator indicates that process 1600 is to be paused or stopped, etc. In response to a determination that process 1600 is complete, process 1600 ends. In response to a determination that process 1600 is not complete, process 1600 returns to 1605.

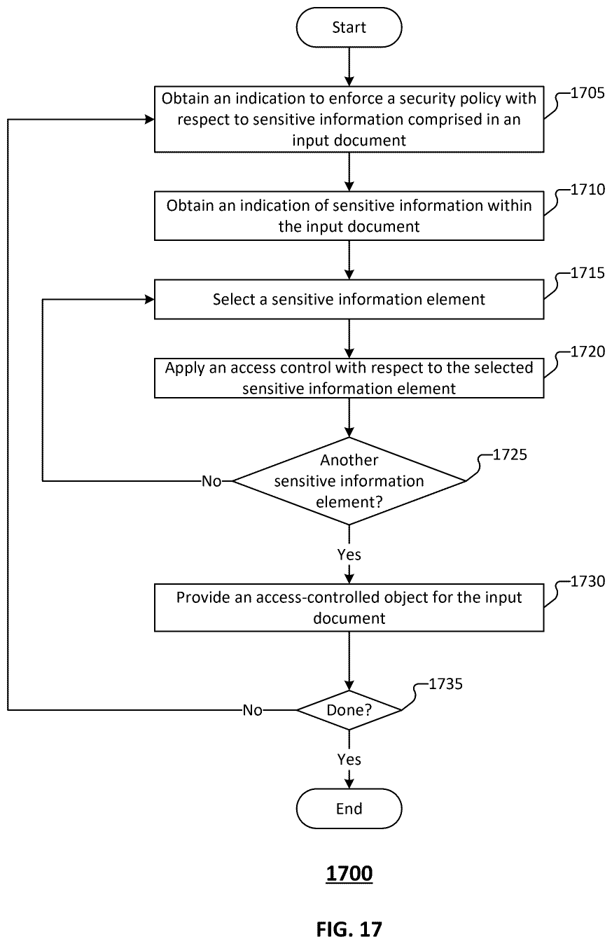

FIG. 17 is a flow diagram of a method for enforcing a security policy with respect to sensitive information in an input document according to various embodiments. According to various embodiments, process 1700 is implemented at least in part by system 100 of FIG. 1. In some embodiments, process 1700 is invoked by process 1300, such as at 1315.

According to various embodiments, once sensitive information is identified, the system applies security policies tailored to the specific requirements of the organization or industry. As an example, the system enforces a predefined security policy, which may be defined for a particular organization (e.g., a customer of the service provided by the system). In some embodiments, the system can enforce access controls by restricting user permissions for entire sections of the document containing sensitive data. For example, users without the appropriate authorization (e.g., without the requisite permissions) are either denied access to these sections or presented with redacted or otherwise obfuscated content. For example, if a section titled “Patient History” contains PHI, the system can make this section visible only to users with specific roles, such as medical professionals, while obscuring it for others.

In some embodiments, in addition to, or rather than, restricting access to entire sections, the system can isolate and secure specific sensitive elements within a section. For instance, if a document includes a patient's medical history along with general procedural information, the system can redact or encrypt only the portions containing PHI while leaving the rest of the section accessible. This granular control ensures compliance with privacy regulations such as Health Insurance Portability and Accountability Act (HIPAA) or General Data Protection Regulation (GDPR) while maintaining usability for non-sensitive data.

In some embodiments, the system also tracks and logs access attempts to sensitive information, providing an audit trail for compliance purposes. The system can dynamically adjust access controls as user permissions change or as organizational policies or regulatory requirements evolve. For example, if a document is shared externally, the system can automatically apply stricter controls, such as masking sensitive sections or requiring additional authentication.

As an illustrative example in a healthcare context, where the system processes a patient's consolidated medical records to identify sections containing PHI, such as treatment notes, test results, or prescriptions. These sections are flagged and secured (e.g., access controls are enforced for these sections), allowing only authorized personnel, such as treating physicians, to view them. For users without the requisite permissions/authorizations to access the sensitive information, the system may generate a redacted version of the document such for administrative staff that excludes sensitive details but retains general procedural information.

Returning to the illustrated example, at 1705, the system obtains an indication to enforce a security policy with respect to sensitive information comprised in an input document. For example, process 1700 may be invoked when a user, system, service, or process attempts to access a document comprising sensitive information. At 1710, the system obtains an indication of the sensitive information within the input document. For example, the system can use the machine-readable object for the input document to identify sections comprising sensitive information, or to specifically identify the sensitive information or type of sensitive information comprised in various sections of the input document. At 1715, the system selects a sensitive information element, for example, in the case that the system determines that the input document comprises a plurality of sensitive information elements. At 1720, the system applies an access control with respect to the selected sensitive information element. At 1725, the system determines whether another sensitive information element is to be protected. In response to determining that another sensitive information element is to be protected (e.g., that the input document comprises another sensitive information element for which an access control has not been applied), process 1700 returns to 1715 and process 1700 iterates over 1715-1725 until no further sensitive information elements are to be processed/protected. In response to determining that no further sensitive information elements are to be processed/protected, process 1700 proceeds to 1730 at which the system provides an access-controlled object (e.g., representation of the input document or section of the input document) for the input document. For example, the system provides the access-controlled object to a system, service, or process that invoked process 1700. At 1735, a determination is made as to whether process 1700 is complete. In some embodiments, process 1700 is determined to be complete in response to a determination that no further input documents are to be processed, no further input documents are to be evaluated for sensitive information, an administrator indicates that process 1700 is to be paused or stopped, etc. In response to a determination that process 1700 is complete, process 1700 ends. In response to a determination that process 1700 is not complete, process 1700 returns to 1705.

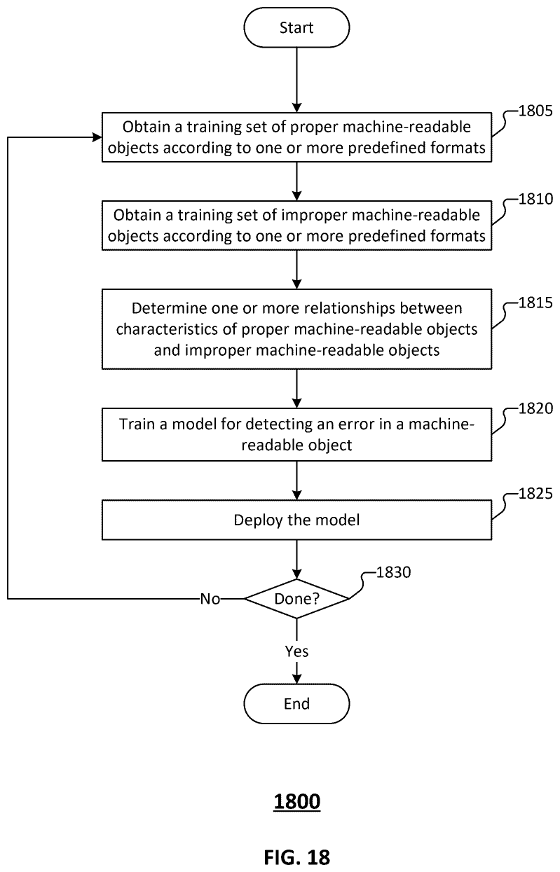

FIG. 18 is a flow diagram of a method for deploying a model to detect errors in a machine-readable object according to various embodiments. According to various embodiments, process 1800 is implemented at least in part by system 100 of FIG. 1. In some embodiments, process 1800 is implemented in connection with training and/or deploying a model for correcting errors in machine-readable objects generated/updated by different models, such as other LLMs.

According to various embodiments, the system trains and deploys a machine learning model for analyzing output objects, such as JSON or YAML files, to identify and correct errors introduced during document processing. This model is tailored to understand the syntax, structure, and semantic content of the output objects (e.g., according to the particular object schema or format), enabling the model to detect inconsistencies, omissions, or formatting errors that may arise when transforming machine-readable text into structured representations. In some embodiments, the training process involves curating a comprehensive dataset of annotated output objects, where each example includes both correct and erroneous versions of the object, along with detailed labels indicating the type and location of errors.

During training, the model learns to recognize common issues such as mismatched or missing brackets, incorrect nesting of elements, invalid syntax, or deviations from predefined schemas. The model can also gain the ability to detect semantic errors, such as incorrect associations between headers and content or misplaced metadata. By analyzing patterns in the training data, the model develops a nuanced understanding of both structural and content-related errors, allowing it to generalize effectively to new, unseen output objects.

Upon training, the system can deploy the model as part of its post-processing pipeline to analyze output objects generated during document processing. The model systematically examines the structure and content of the object, comparing it against expected schemas or rules. For example, if the output object is a JSON file representing an input document's structure, the model verifies that all sections and headers are properly nested, that metadata aligns with the corresponding text, and that no critical elements are missing. The model can flag any deviations as potential errors.

In some embodiments, the model is trained to automatically correct any error or to prompt a user or other system to confirm the error. The model may provide a recommendation for correcting the error. For example, when errors are identified, the system employs the model's correction capabilities to automatically resolve them. These corrections may include reformatting the object to conform to the predefined schema, reassigning misaligned elements, or reprocessing portions of the text to fill in missing information. For instance, if a section header is incorrectly assigned to a sub-header level, the model can adjust its position within the hierarchy. Similarly, if metadata for a section is incomplete or inaccurate, the model can recompute the metadata by analyzing the associated text and update the object accordingly.

In some embodiments, the system validates the model's corrections by cross-referencing them with the original machine-readable text and predefined rules. This ensures that the corrected output not only adheres to the required format but also aligns with the input document's content and context. In cases where the model encounters ambiguous errors or conflicts, the system can flag these instances for manual review, ensuring a high level of accuracy and reliability.

In some embodiments, the system implements a feedback loop where corrections and flagged issues are incorporated back into the training dataset, for example, to continuously improve the system performance. Over time, this iterative process can enable the model to refine its understanding of error patterns and develop more robust correction strategies. Additionally, the system may deploy different versions of the model trained on specific output formats, such as JSON or YAML, ensuring specialized expertise for each type of object.

By training and deploying a machine learning model specifically for analyzing and correcting output objects, the system enhances the reliability and accuracy of document processing workflows. It ensures that structured representations, such as JSON or YAML files, are free from errors and accurately capture the content and structure of the original input documents.

Returning to the illustrated example, at 1805, the system obtains a training set of proper machine-readable objects according to one or more predefined formats (e.g., JSON, XML, YAML, etc.). A proper machine-readable object may be an error-free machine-readable object (e.g., a JSON file, a YAML file, etc.). At 1810, the system obtains a training set of improper machine-readable objects according to one or more predefined formats. A proper machine-readable object may be a machine-readable object (e.g., a JSON file, a YAML file, etc.) comprising an error(s). At 1815, the system determines one or more relationships between characteristics of proper machine-readable objects and improper machine-readable objects. At 1820, the system trains a model for detecting (and in some embodiments for correcting or recommending a correction) an error in a machine-readable object. At 1825, the system deploys the model, such as in the post-processing pipeline. At 1830, the system determines whether process 1800 is complete. In some embodiments, process 1800 is determined to be complete in response to a determination that no further models are to be trained or deployed, an administrator indicates that process 1800 is to be paused or stopped, etc. In response to a determination that process 1800 is complete, process 1800 ends. In response to a determination that process 1800 is not complete, process 1800 returns to 1805.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

1. A system, comprising:
one or more processors configured to:
obtain input text for an input document;
obtain an output object for the input document, wherein obtaining the output object comprises:
querying a first machine learning model to obtain a machine-readable object that indicates a document structure, for the input text, comprising at least one of a section header, a section identifier, a sub-section header, a sub-section identifier, a section start location, a section end location, an intra-document cross-reference, an inter-document cross-reference, a document type, a document title, a document date, entity identifiers, a section type, a section summary, keywords, an indication of sensitive information within a section, or a hierarchical representation; and
performing a post-processing of the machine-readable object to obtain the output object, wherein the post-processing comprises correcting errors, introduced by the first machine learning model in the machine-readable object obtained upon querying the first machine learning model, comprising at least one of a syntax error, a formatting error, a deviation from a predefined schema, an incorrect nesting of an element, a missing section header, a missing section identifier, an incorrect header not present in the input text, incorrect metadata, misaligned metadata, a misclassified section, an incorrect association between a header and content, incomplete metadata, inaccurate metadata, or misplaced metadata; and
provide the output object; and
a memory coupled to the one or more processors and configured to provide the one or more processors with instructions.

2. The system of claim 1, wherein the first machine learning model comprises a large language model (LLM).

3. The system of claim 1, wherein the machine-readable object is a JavaScript Object Notation (JSON) object.

4. The system of claim 1, wherein the machine-readable object is one of: (a) a JSON object, (b) a Yet Another Markup Language (YAML) object, (c) an eXtensible Markup Language (XML) object, and (d) a Protocol Buffers object.

5. The system of claim 1, wherein obtaining the input text for the input document comprises:
obtaining the input document; and
converting the input document to the input text, wherein the input text is machine-readable text.

6. The system of claim 5, wherein converting the input document to the input text comprises performing optical character recognition (OCR) with respect to the input document.

7. The system of claim 1, wherein the one or more processors are further configured to:
filter out the input document in response to a determination that the input text does not comprise any headers.

8. The system of claim 7, wherein the one or more processors are further configured to:
determine whether to filter out the input document based at least in part on an output from querying the first machine learning model, wherein the output corresponds to a threshold percentage of the input document.

9. The system of claim 8, wherein determining whether to filter out the input document based at least in part on an output from querying the first machine learning model comprises:
determining whether the output is indicative of the input document comprising headers; and
in response to determining that the output does not indicate that the input document comprises headers, determining to filter out the input document.

10. The system of claim 9, wherein in response to determining to filter out the input document, processing of a remainder of the input text is stopped.

11. The system of claim 1, wherein:
obtaining the output object for the input document comprises segmenting the input text into a set of one or more chunks; and
querying the first machine learning model to obtain the machine-readable object comprises iteratively selecting a particular chunk from the set of one or more chunks, and querying the first machine learning model based at least in part on the set of one or more chunks.

12. The system of claim 11, wherein the input text is segmented into the set of one or more chunks based at least in part on a predetermined chunk size.

13. The system of claim 11, wherein querying the first machine learning model based at least in part on the set of one or more chunks comprises iteratively selecting a particular chunk from the set of one or more chunks, and querying the first machine learning model based at least in part on the particular chunk.

14. The system of claim 11, wherein querying the first machine learning model based at least in part on the set of one or more chunks comprises querying the first machine learning model to process in parallel a plurality of chunks from the set of one or more chunks.

15. The system of claim 1, wherein the performing the post-processing of the machine-readable object to obtain the output object comprises:
querying a second machine learning model to identify errors comprised in the output object that are generated by the first machine learning model and cause the errors to be corrected.

16. The system of claim 15, wherein the second machine learning model is trained specifically on a predefined format or syntax of the output object.

17. The system of claim 1, wherein the machine-readable object comprises an indication of a set of one or more headers or section identifiers for the input text.

18. The system of claim 17, wherein the performing the post-processing of the machine-readable object to obtain the output object comprises:
validating that each header or section identifier comprised in the output object exists within the input text.

19. The system of claim 1, wherein:
the machine-readable object comprises an indication of a set of one or more headers or section identifiers for the input text; and
performing the post-processing of the machine-readable object comprises querying a third machine learning model to obtain sub-section headers or sub-section identifiers.

20. The system of claim 19, wherein the third machine learning model is the same as the first machine learning model.

21. The system of claim 1, wherein the one or more processors are further configured to:
determine one or more cross references within the input document based at least in part on the output object.

22. The system of claim 21, wherein the one or more processors are further configured to:
update the output object to comprise metadata indicating the one or more cross references within the input document; or
generating a representation of the input document, the representation comprising hyperlinks comprising pointers associated with the one or more cross references.

23. The system of claim 1, wherein the one or more processors are further configured to:
determine one or more cross references across a set of two or more documents based at least in part on the output object.

24. The system of claim 23, wherein documents comprised in the set of two or more documents are determined to be related based at least in part on respective output objects.

25. The system of claim 23, wherein the one or more processors are further configured to:
generate an aggregated document based at least in part on the one or more cross references across the set of two or more documents.

26. The system of claim 1, wherein the one or more processors are further configured to:
determine, based at least in part on the output object, sections of the input document comprising sensitive information; or
identify, based at least in part on the output object, sensitive information or sections comprising sensitive information.

27. The system of claim 26, wherein the sensitive information comprises personally identifiable information or protected health information.

28. The system of claim 26, wherein the one or more processors are further configured to:
cause one or more security policies or access controls to be applied with respect to the sensitive information.

29. A method, comprising:
obtaining input text for an input document;
obtaining an output object for the input document, comprising:
querying a first machine learning model to obtain a machine-readable object that indicates a document structure, for the input text, comprising at least one of a section header, a section identifier, a sub-section header, a sub-section identifier, a section start location, a section end location, an intra-document cross-reference, an inter-document cross-reference, a document type, a document title, a document date, entity identifiers, a section type, a section summary, keywords, an indication of sensitive information within a section, or a hierarchical representation; and
performing a post-processing of the machine-readable object to obtain the output object, wherein the post-processing comprises correcting errors introduced by the first machine learning model in the machine-readable object obtained upon querying the first machine learning model; and
providing the output object.

30. A computer program product embodied in a non-transitory computer readable medium and comprising computer instructions for:
obtaining input text for an input document;
obtaining an output object for the input document, comprising:
querying a first machine learning model to obtain a machine-readable object that indicates a document structure for the input text; and
performing a post-processing of the machine-readable object to obtain the output object, wherein the post-processing comprises correcting errors, introduced by the first machine learning model in the machine-readable object obtained upon querying the first machine learning model, comprising at least one of a syntax error, a formatting error, a deviation from a predefined schema, an incorrect nesting of an element, a missing section header, a missing section identifier, an incorrect header not present in the input text, incorrect metadata, misaligned metadata, a misclassified section, an incorrect association between a header and content, incomplete metadata, inaccurate metadata, or misplaced metadata; and
providing the output object.
